(19) United States
(12) Patent Application Publication
(10) Pub. No.: US 2024/0114826 A1
(43) Pub. Date: Apr. 11, 2024

(54) AUTOMATED LOCKOUT SYSTEM

(71) Applicant: DEERE & COMPANY, MOLINE, IL (US)

(72) Inventors: SHREYAS P. MODAK, THANE (IN); ALEX BRIMEYER, BETTENDORF, IA (US); SHALLY JARQUIN CADENA, Monterrey (MX)

(21) Appl. No.: 17/938,705

(22) Filed: Oct. 7, 2022

(51) Int. Cl. A01D 34/00; A01D 34/04; A01D 69/03

(52) U.S. Cl. CPC A01D 34/006; A01D 34/04; A01D 69/03

(57) ABSTRACT

Systems and methods for automatically altering a configuration of a cutterbar of a header in response actuation of a gauge wheel of the header may include sensing a position of a gauge wheel with a sensor. For example, the sensor senses at least one of extension and retraction of the gauge wheel, and, in response, the sensor causes the cutterbar to alter a configuration thereof. In some instances, the sensor includes a switch that forms one of a closed electrical circuit or an open electrical circuit in response to actuation of the gauge wheel. In response, at least one actuator is actuated to move the cutterbar into one of the flexible configuration and the rigid configuration.

### FIELD OF THE DISCLOSURE

The present disclosure relates generally to agricultural headers and, particularly, to agricultural headers having cutters movable between a flexible configuration and a rigid configuration.

### BACKGROUND OF THE DISCLOSURE

Agricultural harvesters use a variety of implements to gather crops. A “draper” or “draper header” is one such type of these implements. Conventional draper headers use conveyors with endless belts to carry cut crop material from leading-edge knives (also referred to as a cutter or cutterbar) to center regions of the headers. From there, the cut crop material is conveyed into the harvester, such as a combine harvester. Once in the combine harvester, the cut crop material is further processed by separating grain from unwanted crop material (typically called “material other than grain” or “MOG”).

### SUMMARY OF THE DISCLOSURE

A first aspect of the present disclosure is directed to a system for automatically configuring a cutterbar of an agricultural header. The system may include a gauge wheel moveable between an extended position and a retracted position; a sensor that detects a position or an amount of movement of the gauge wheel; and a cutterbar movable between a flexible configuration and a rigid configuration. The cutterbar may be moveable into the rigid configuration in response to detection, by the sensor, of a selected position or a selected amount of movement of the gauge wheel as the gauge wheel moves into the extended position.

Another aspect of the present disclosure is directed to a method of automatically configuring a cutterbar of an agricultural header. The method may include moving a gauge wheel by one of extending and retracting the gauge wheel of an agricultural header; sensing movement of the gauge wheel with a sensor; and automatically moving a cutterbar of the agricultural header into one of a rigid configuration when the sensed movement of the gauge wheel is extension of the gauge wheel and a flexible configuration when the sensed movement of the gauge wheel is retraction of the gauge wheel.

The various aspects may include one or more of the following features. The sensor may include a switch, and the switch may be actuated in response to at least one of extension of the gauge wheel and retraction of the gauge wheel. Actuation of the switch in response to extension of the gauge wheel may include moving the switch to form one of a closed electrical circuit and an open electrical circuit. The sensor may include a pivotable rotor that includes a surface. The switch may include an arm that follows the surface. A rod may extend between the gauge wheel and the pivotable rotor of the sensor. The rod may be moveable in response to movement of the gauge wheel to cause the rotor to pivot about an axis. Extension of the gauge wheel may include rotation of the gauge wheel about a first axis in a first rotational direction. The rotor may be pivoted by the rod in response to movement of the gauge wheel in one of the first rotational direction or a second rotational direction, opposite the first direction. The surface may include a ramp. The arm may follow the ramp to actuate the switch to form one of an open electrical circuit and a closed electrical circuit. A position or an amount of movement of the gauge wheel detected by the sensor may include a position or an amount of movement corresponding to a selected amount of extension of the gauge wheel. The selected amount of extension of the gauge wheel may include an amount of extension within a range of 10% to 20% of an entirety of extension of the gauge wheel. At least one pivotably mounted float arm may be included. The at least one pivotably mounted float arm may be connected to the cutterbar at a first end. The at least one pivotably mounted float arm may be moveable between a freely pivotably condition and a fixed condition. The at least one pivotably mounted float arm may be in the freely pivotably condition when the cutterbar is in the flexible condition, and the at least one pivotably mounted float arm may be moved to the fixed condition to place the cutterbar in the rigid configuration in response to detection of the position of the gauge wheel by the sensor.

The various aspects may include one or more of the following features. Sensing movement of the gauge wheel with a sensor may include actuating an electrical switch. Sensing movement of the gauge wheel with a sensor may include pivoting a rotor of the sensor that includes a profiled surface. Pivoting the rotor may include following the profiled surface of the rotor with an arm of the sensor to form one of an open electrical circuit or a closed electrical circuit. Pivoting a rotor that includes the profiled surface may include displacing a rod extending between the gauge wheel and the rotor and rotating the rotor a selected amount about an axis in response to the displacement of the rod. The gauge wheel may include a gauge wheel assembly. The gauge wheel assembly may include an arm. The gauge wheel may be pivotably attached to the gauge wheel arm. The rod may be pivotably attached at a location along the gauge wheel arm at a first end and pivotably attached to the rotor at a second end. Automatically moving a cutterbar of the agricultural header into one of a rigid configuration when the sensed movement of the gauge wheel is extension of the gauge wheel and a flexible configuration when the sensed movement of the gauge wheel is retraction of the gauge wheel may include pivoting a float arm from one of a first position in which the float arm is in a freely pivotable condition and a second position in which the float arm is in a fixed condition. The cutterbar may be attached to a distal end of the float arm. Pivoting the float arm from one of the first position in which the float arm is in the freely pivotable condition and the second position in which the float arm is in the fixed condition may include one of extending and retracting a linear actuator. The linear actuator may include a fluidic cylinder.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is an oblique view of an example draper header, according to some implementations of the present disclosure.

FIG. 2 is oblique view of a portion of a frame of an example header, according to some implementations of the present disclosure.

FIG. 3 is a transverse cross-sectional view of an example header, according to some implementations of the present disclosure.

FIG. 4 is a transverse cross-sectional view of another example header, according to some implementations of the present disclosure.

FIG. 5 is a top schematic view of a portion of an example header having a plurality of actuators to alter a configuration of a cutterbar of the header, according to some implementations of the present disclosure.

FIG. 6 is a side view of an example header having a single actuator to alter a configuration of a cutterbar of the header, according to some implementations of the present disclosure.

FIG. 7 is cross-sectional view of portions of an example lockout system, according to some implementations of the present disclosure.

FIG. 8 is an oblique view of the lockout system of FIG. 7.

FIG. 9 is a detailed, cross-sectional view of a portion of the lockout system of FIG. 7.

FIG. 10 is another detailed, cross-sectional view of a portion of the lockout system of FIG. 7.

FIG. 11 is a detail view of a portion of an example header showing a system for detecting a position of a gauge wheel and automatically controlling a configuration of a cutterbar in response to the detected position of the gauge wheel.

FIGS. 12 through 14 are detail views of a portion of the example header of FIG. 11 showing rotation of a rotor of an example sensor that detects a position of one or more gauge wheels of the example header.

FIG. 15 is a schematic diagram showing an example system used to extend and retract actuators in response to a detected position of a gauge wheel, according to some implementations of the present disclosure.

FIG. 16 a detail view of a portion of an example header showing a system for detecting a position of a gauge wheel and automatically controlling a configuration of a cutterbar in response to the detected position of a gauge wheel.

FIG. 17 through 18 are detail views of a portion of the example header of FIG. 16 showing rotation of a rotor of an example sensor that detects a position of one or more gauge wheels of the example header.

FIG. 19 is a schematic diagram showing another example system used to extend and retract actuators in response to a detected position of a gauge wheel, according to some implementations of the present disclosure.

FIG. 20 is a side view of another example lockout system, according to some implementations of the present disclosure.

FIG. 21 is an oblique view of the lockout system of FIG. 20.

FIG. 22 is schematic view of an example control system for automatically configuring a cutterbar of an agricultural header in response to movement of a gauge wheel, according to some implementations of the present disclosure.

FIG. 23 is a flowchart of an example method for automatically configuring a cutterbar, according to some implementations of the present disclosure.

FIG. 24 is a block diagram illustrating an example computer system used to provide computational functionalities associated with described algorithms, methods, functions, processes, flows, and procedures as described in the present disclosure, according to some implementations of the present disclosure.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

The present disclosure is directed to agricultural headers and, particularly, to draper headers that include lockout systems that are movable between a flexible configuration and a rigid configuration. In the flexible configuration, float arms of the header are freely pivotable about respective axes, and, in the rigid configuration, the float arms are in a fixed position thereby providing a knife attached to the float arms in a rigid configuration. For example, in the rigid configuration, the float arms are retracted, such as into contact with a portion of the header. In the rigid configuration, the knife is prevented from flexing, such as in response to changing field topography. In some instances, the lockout systems provide for abutting contact between the float arms and another portion of the header frame. Further, the headers are automated in that movement of one or more gauge wheels of the header between retracted and extended positions is sensed, and detection of such movement or movement by a selected amount causes automatic movement of the knife into the flexible configuration and the rigid configuration, as described in more detail below.

Words of orientation, such as “up,” “down,” “top,” “bottom,” “above,” “below,” “leading,” “trailing,” “front,” “back,” “forward,” and “rearward” are used in the context of the illustrated examples as would be understood by one skilled in the art and are not intended to be limiting to the disclosure. For example, for a particular type of vehicle or implement in a conventional configuration and orientation, one skilled in the art would understand these terms as the terms apply to the particular vehicle or implement.

As used herein, with respect to a header (or components thereof), unless otherwise defined or limited, the term “leading” (and the like) indicates a direction of travel of the header during normal operation (e.g., the forward direction of travel of an agricultural vehicle carrying a header). Similarly, the term “trailing” (and the like) indicates a direction that is opposite the leading direction. In this regard, for example, a “leading” edge of a knife assembly of a draper header may be generally disposed at the front of the knife assembly, with respect to the direction travel of the draper header during normal operation (e.g., as carried by an agricultural harvester). Likewise, a “trailing” edge of the knife assembly may be generally disposed at the back or a side of the knife assembly opposite the leading edge, with respect to the direction of travel of the draper header during normal operation.

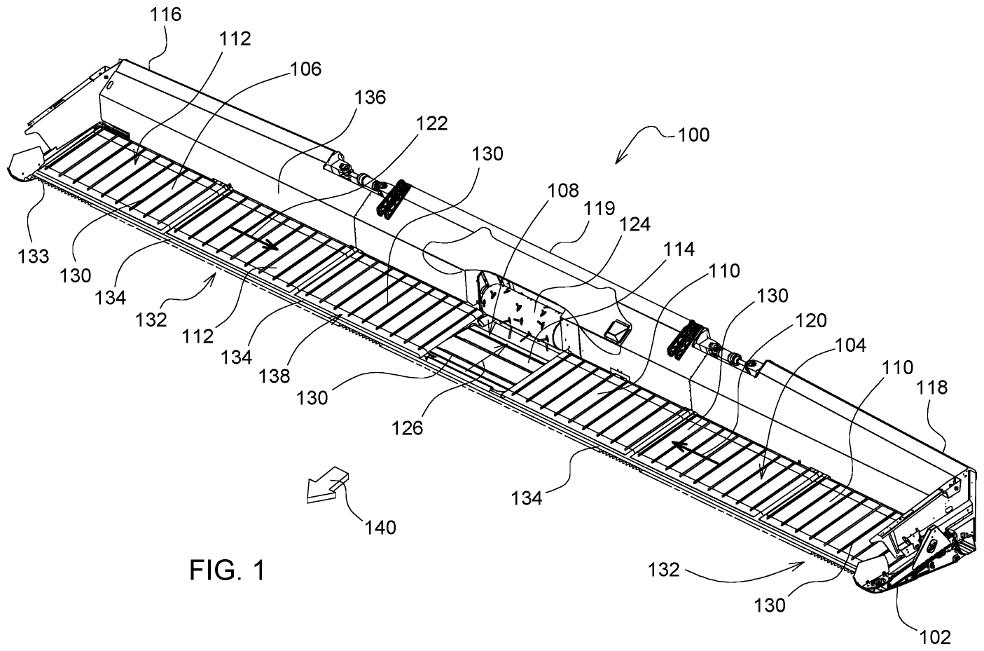

FIG. 1 shows an example draper header 100 that includes a frame 102 that supports a first side conveyor 104, a second side conveyor and 106, and a center conveyor 108. Each of the conveyors 104, 106, and 108 is configured as a belt-type conveyor extending over a respective circumferential length. The conveyors 104, 106, and 108 include endless belts 110, 112, and 114 that are moved in respective loops along the header 100 by motive devices, such as motors, gears, or internal belts. The conveyors 104 and 106 are disposed on opposing wings 116 and 118, respectively, of the header 100. In some implementations, the wings 116 and 118 are pivotable relative to a center section 119. In other implementations, the wings 116 and 118 are fixed relative to the center section 119. In the illustrated example, the conveyor 104 includes two endless belts 110, and the conveyor 106 includes two endless belts 112. In other implementations, the conveyors 104 and 106 may include additional or fewer endless belts. Further, although the conveyor 108 is shown as including a single endless belt 114, in other implementations, the conveyor 108 may include additional endless belts. The endless belts 110, 112, and 114 are supported on two or more rollers of the respective conveyors 104, 106, and 108. Although the draper header 100 is illustrated as a rigid or non-folding draper header, the scope of the present disclosure encompasses folding draper headers.

In some implementations the endless belts 110, 112, and 114 may be formed from elastomer-impregnated fabric belts. Generally, the endless belts 110 and 112 may be rotated such that upper surfaces of the endless belts 110 and 112 move inward along the header 100 in respective directions 120 and 122. In this way, material, such as severed crop material, is moved by the endless belts 110 and 112 to the center conveyor 108, which, in turn, uses the endless belt 114 to move the material off of the header 100. For example, the header 100 may offload the material onto an agricultural harvester to which the header 100 is attached. The header 100 also includes a cylindrical conveyor 124. The cylindrical conveyor 124 receives severed crop material from the center conveyor 108 and carries the crop material rearward (i.e., in a direction 126) through an aperture in the frame 102 located between the cylindrical conveyor 124 and the center conveyor 108 and, ultimately, into the agricultural harvester.

In the illustrated example, various cleats 130 are fixed to the surface of each of the endless belts 110, 112, and 114, with the cleats 130 generally extending in a direction transverse to the direction of travel of the respective endless belt 110, 112, or 114, e.g., directions 120, 122, and 126. In some implementations, the cleat 130 may extend less than an entire width of the endless belts 110, 112, and 114. For example, one or more of the cleats 130 may extend only partially across the respective width of the endless belts 110, 112, and 114, and, accordingly, may not extend to a leading edge or a trailing edge of the belts 110, 112, and 114.

The header 100 also includes a cutterbar 132 at a leading edge 133 of the header 100. The cutterbar 132 cuts crop material, such as to sever crop material from a field. The cutterbar 132 extends laterally along the header 100.

During a harvesting operation, an agricultural harvester carries the header 100 through an agricultural field in a nominal forward direction 140. As the header 100 is moved across the field, the cutterbar 132 operates to sever the crops at a location adjacent to the ground. The severed crop material generally falls in a trailing direction (i.e., generally opposite the direction 140), onto one or more of the three conveyors 104, 106, and 108. The conveyor 104 on the wing 118 carries the crop material in the direction 120, using the endless belts 110, toward the center of the header 100. The conveyor 106 carries the severed crop material in the direction 122, using the endless belts 112, toward the center conveyor 108, and the center conveyor 108 carries the severed crop material in the direction 126 towards and underneath the cylindrical conveyor 124. The severed crop material from the cylindrical conveyor 124 is transported in the direction 126 through the aperture in the frame 102 of the header 100 and into the agricultural harvester.

In the illustrated example, the conveyor 104 and the conveyor 106 are similarly configured, although the conveyors 104 and 106 carry crop material in opposite directions 120 and 122, respectively. In other implementations, the conveyors 104 and 106 can be configured differently. Generally, however, the description herein of the conveyor 104 is applicable to the conveyor 106, as well as other conveyors of other implementations.

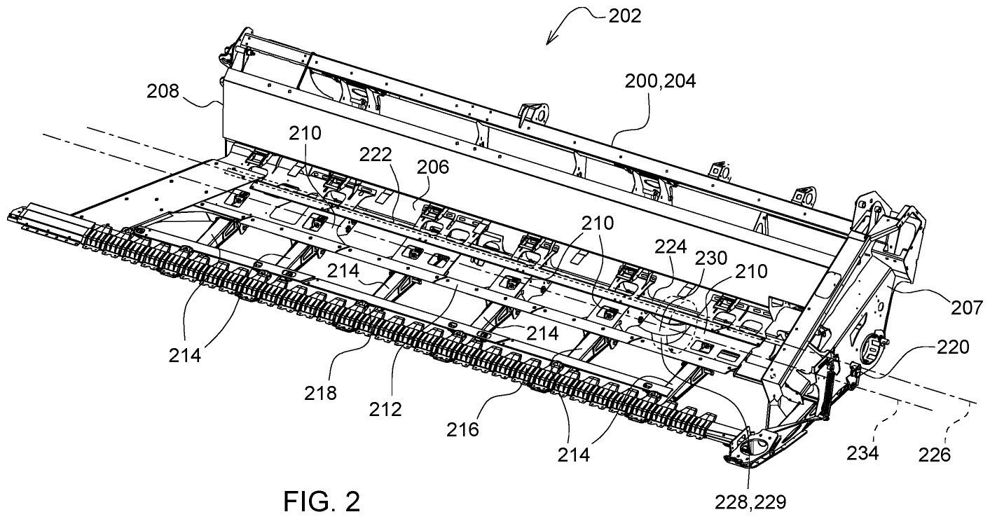

FIG. 2 is a view of a portion of a frame 200 of a header 202, which may be similar to the header 100. The portion of the frame 200 illustrated corresponds to a portion of a wing 204 of the header 202. The wing 204 may be similar to wing 118 of the header 100. As explained above, the wing 118 may be pivotably attached, or the wing 118 may be fixed on the header 100. The frame 200 includes a beam 206 extending laterally along the frame 200. A back section 208 is coupled to the beam 206 and extends therefrom. The back section 208 also extends laterally along the frame 200. An outboard side section 207 connects to the beam 206 and the back section 208 and defines a lateral end of the frame 200. A plurality of mounting brackets 210 are also coupled to the beam 206. With the header 202 conventionally oriented, the mounting brackets 210 general extend in a direction corresponding to a forward direction. The frame 200 also includes a laterally extending cross tube 212 that connects to each of the mounting brackets 210. In some implementations, the cross tube 212 may have a square, rectangular, or circular cross-sectional shape and may define a central passage. However, the cross tube 212 may have other cross-sectional shapes. Float arms 214 are pivotably coupled to the mounting brackets 210, and a cutterbar 216 is coupled to distal ends 218 of each of the float arms 214. Similar to the cutterbar 132, the cutterbar 216 is a reciprocating cutterbar.

In some implementations, the mounting brackets 210 and corresponding float arms 214 are laterally separated from adjacent mounting brackets 210 and corresponding float arms 214 by approximately 2.5 feet (ft) (0.8 meters (m)). In other implementations, the lateral separation 215 may be greater than or less than 2.5 ft (0.8 m). In still other implementations, the lateral separation 215 may vary. Thus, in some implementations, the lateral separation 215 between some adjacent mounting brackets 210 and corresponding float arms 214 may be uniform while the lateral separation between other adjacent mounting brackets 210 and corresponding float arms 214 may be non-uniform.

With the header 202 in an unsecured or flexible configuration, each of the float arms 214 is able to pivot independently of the other float arms 214. As a result, when the float arms 214 are in contact with the ground and propelled over the ground, such as during a harvesting operation, each of the float arms 214 is able to follow a topography or contour of the ground. In response to the float arms 214 conforming movement to the contour of the ground, the cutterbar 216 flexes to also conform to the contour of the ground. As a result, a portion of the crop extending from the ground and remaining in a field may be generally consistent, e.g., a height by which the crop remaining in field extends from the ground is generally uniform.

In a rigid configuration in which the float arms 214 are held in an abutting relationship against a portion of the frame 200, such as the cross tube 212, the float arms 214 are prevented from following a contour of the ground, and the cutterbar 216 is maintained in a generally straight and rigid configuration, e.g., the cutterbar 216 maintains a generally straight, unbent shape.

The header 202 also includes a lockout system 220 that is operable to move the float arms 214 and the cutterbar 216 between the flexible configuration and the rigid configuration. In some implementations, the header 202 includes a lockout system 220 for each wing 204. The separate lockout systems 220 are operable to move the float arms 214 and associated portion of the cutterbar 216 of one wing between the rigid configuration and the flexible configuration independently of the float arms 214 and associated portion of the cutterbar 216 of the other wing. Thus, in some implementations, the header 202 may include two lockout systems 220. In other implementations, the header may include a single lockout system 220 for all of the wings of the header 202. In still other implementations, the header 200 may include more than two lockout systems.

The lockout system 220 includes a rotatable component, which, in the example of FIG. 2, is a lockout tube 222. In some implementations, the lockout tube 222 is in the form of a shaft. The lockout tube 222 extends laterally along the header 202 through apertures 224 formed in each of the mounting brackets 210. The lockout tube 222 is rotatable relative to the mounting brackets 210 about a centerline 226.

The header also includes gauge wheels 228, as shown in FIG. 2. In some implementations, the header 200 includes two gauge wheels 228 distributed laterally along each wing of the header 200. In other implementations, the header 200 includes fewer or additional gauge wheels 228. FIG. 2 illustrates a single gauge wheel 228, although, as explained earlier, the scope of the disclosure is not so limited.

A gauge wheel assembly 229 includes the gauge wheels 228 and an arm 230 to which the gauge wheels are rotatably coupled. The arms 230 are pivotably coupled to a mounting bracket 210. The gauge wheels assemblies 229 are movable between a retracted position and an extended position.

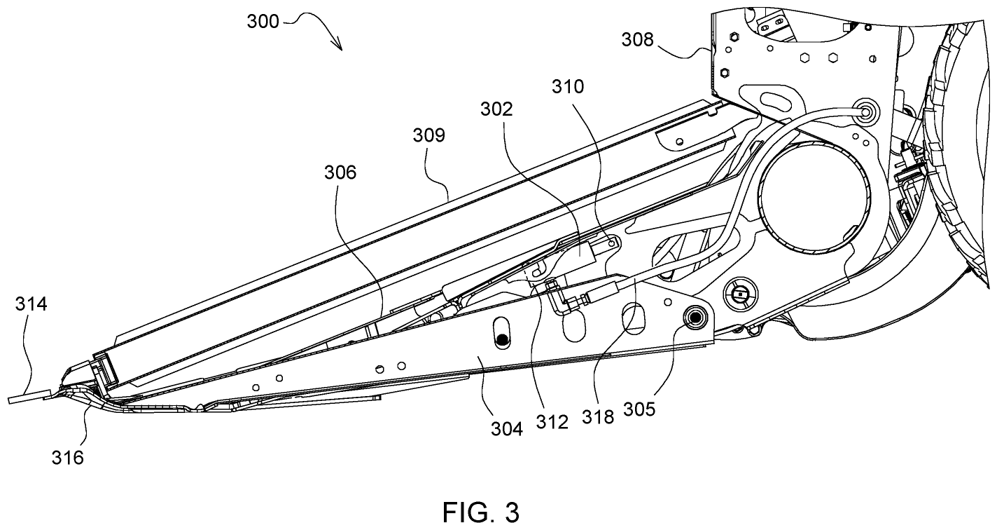

FIG. 3 illustrates another example header 300 that is similar to the header 100 and 200. The header 300 includes one or more actuators 302 that extends between a float arm 304 and frame 308 of the header 300. The float arm 304 is pivotably attached to a mounting bracket 306 of the frame 308 about an axis 305. In some instances, the actuators 302 are attached to the mounting bracket 306. In other instances, one or more of the actuators 302 is attached to another portion of the frame 308. In some instance, the actuators 302 are pivotably coupled to the respective float arm 304 and the frame 308. Example actuators 302 include, for example, a hydraulic cylinder, a pneumatic cylinder, or an electrically operated linear actuator. In other implementations, other types of actuators may be used, such as a rotary actuator. A conveyor 309 of the header 300 is also illustrated. The conveyor 309 may be similar to any one of the conveyors 104, 106, and 108 described earlier.

As shown in FIG. 3, a first end 310 of the actuator 302 is attached to the float arm 304, and a second end 312 of the actuator 302 is attached to frame 308. In this configuration, extension of the actuator 302 causes the float arm 304 to move into the rigid configuration in which the float arm is in a fixed condition (e.g., in contact with a portion of header such as to prevent pivoting movement). In the rigid configuration, a cutterbar 314 attached at a distal end 316 of the float arm 304 is made rigid, such as by being maintained in a generally straight, unbent shape. Retraction of the actuator 302 moves the float arm 304 into the flexible configuration in which the float arm 304 is freely pivotable about axis 305. In the flexible configuration, the cutterbar 314 is able to flex and follow a contour of the ground, as described earlier. Hydraulic pressure, pneumatic pressure, or electrical power may be provided to the actuator 302 via line 318 (e.g., a conduit, tube, hose, or other component configured to carry or transmit power to the actuator 302).

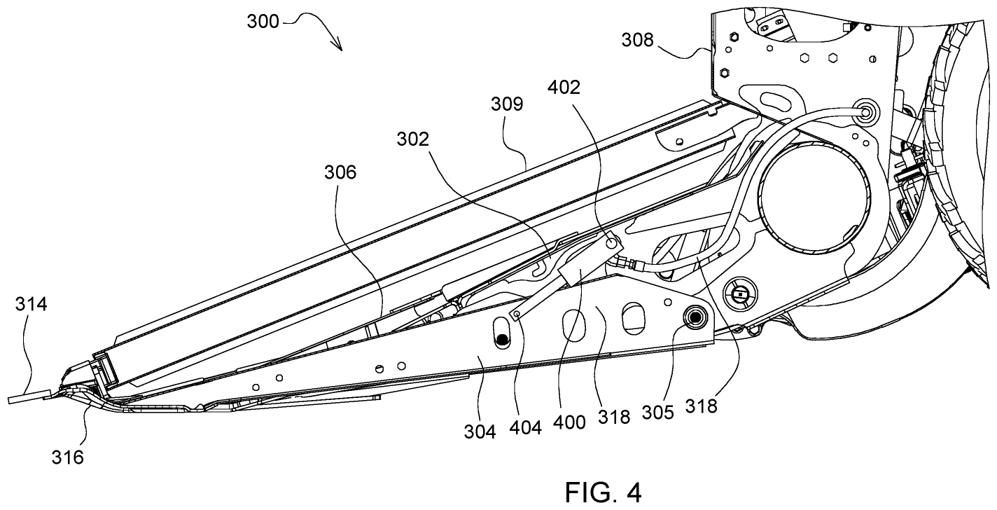

In other implementations, an actuator may be arranged differently. For example, FIG. 4 shows another example actuator 400 provided on header 300. The actuator 400 extends between the float arm 304 and the mounting bracket 306 or another part of the frame 308 of the header 300. In this example, a first end 402 of the actuator 400 is pivotably attached to the mounting bracket 306, and a second end 404 of the actuator 400 is pivotably attached to the float arm 304. In this example, extension of the actuator 400 moves the float arm 304 into the flexible configuration in which the cutterbar 314 is able to flex and follow a contour of the ground. Retraction of the actuator 400 moves the float arm 304 into the rigid configuration in which the cutterbar 314 is maintained rigidly in a generally straight shape. Thus, in both example configurations illustrated in FIGS. 3 and 4, actuation of the respective actuators 302 and 400 is operable to move the cutterbar between a rigid configuration and a flexible configuration.

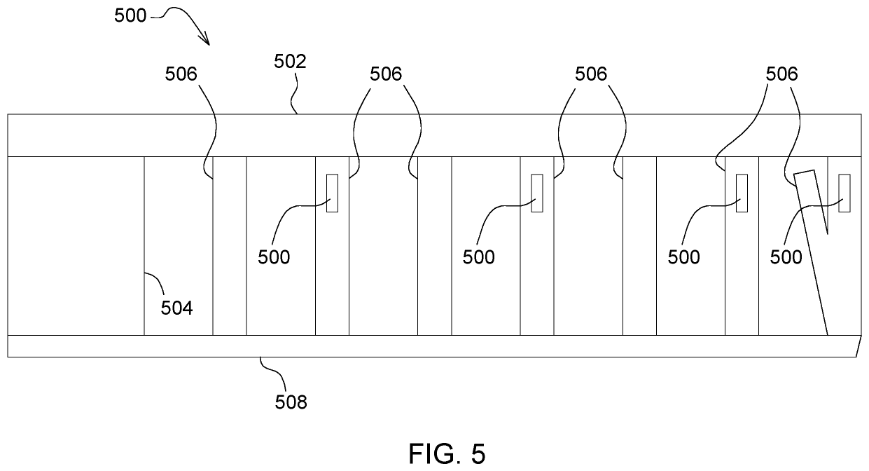

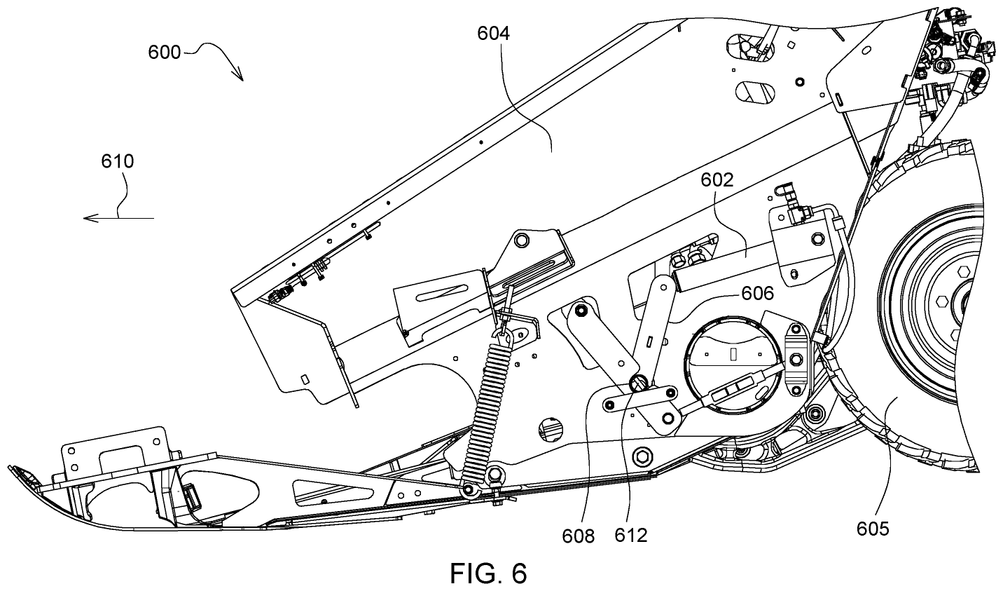

Although a single actuator 302 and 400 is illustrated in FIGS. 3 and 4, respectively, a header within the scope of the present disclosure may include one or a plurality of actuators. FIG. 5 is a top schematic view of a portion of an example header 500 that includes a plurality of actuators 502. The portion of the header 500 illustrated includes a portion of a frame 502, a center section 504, a plurality of float arms 506, and a cutterbar 508 extending along a leading end 510 of the header 500. Actuators 512 are illustrated, and each actuator 512 is associated with a respective float arm 506. As shown, an actuator 512 is associated with some float arms 506 and not with others. For example, in some implementations, an actuator 512 is associated with every other float arm 506. That is, in some instances, an actuator 512 is provided with alternating float arms 506. In the illustrated example, an actuator 512 is provided with the adjacent, outermost float arms 506. In still other implementations, actuators 512 may be applied in any arrangement with respect to the float arms 506. For example, in some implementations, a single actuator is used to actuator the float arms between the flexible configuration and the rigid configuration, as illustrated in FIG. 6.

As mentioned, in some implementations, a single actuator is used in combination with a lockout system to move the float arms and, hence the cutterbar, between the rigid configuration and the flexible configuration. FIG. 6 is a side view of an example header 600 that includes an actuator 602 located on a side 604 of the header 600 and a gauge wheel 605 that is movable between an extended position and a retracted position. In some instances, the actuator 602 may be provided at other locations on the header. The gauge wheel 605 is shown in the retracted position. The actuator 602 is coupled to a lever arm 606 that is fixedly attached to a shaft 608. The shaft 608 extends laterally along the header 600, for example in a direction generally perpendicular to a forward direction indicated by arrow 610. The shaft 608 is coupled to a plurality of the float arms of the header 600. In some implementations, the shaft 608 is coupled to all of the float arms. In other implementations, the shaft is coupled to fewer than all of the float arms. For example, in some implementations, the shaft is coupled to alternating float arms. Actuation of the actuator 602 rotates the shaft 608 about a longitudinal axis 612 thereof. Rotation of the shaft 608 causes all of the float arms to move, such as to position the float arms in the flexible configuration or the rigid configuration. In those implementations in which the shaft 608 is coupled to fewer than all of the float arms, the cutterbar, which is coupled to all of the float arms, functions to move the float arms not otherwise coupled to the shaft 608 as described below when the actuator is operated. In some implementations, the actuator 602 is a linear actuator, such as a hydraulic, pneumatic, or electrical linear actuator. In other implementations, the actuator 602 can be other types of actuators, such as a rotary actuator.

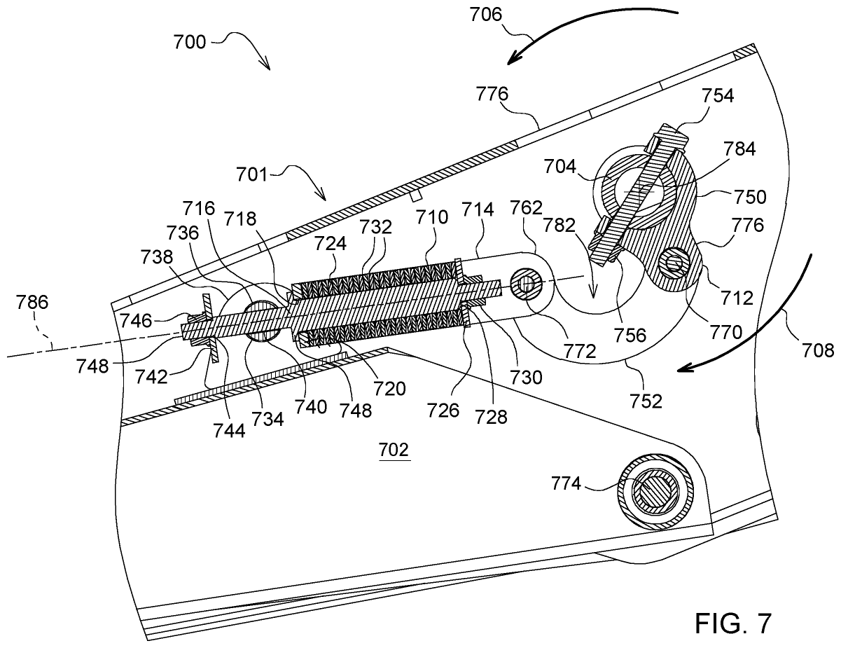

In some implementations, a header, which may be similar to header 100, includes a lockout system 700, shown in FIG. 7, that functions to move float arms 702 and associated portions of a cutterbar provided at the distal ends of the float arms 702 of the header between a flexible configuration and a rigid configuration. The lockout system 700 may be included on the header 600 of FIG. 6 and used in combination with the actuator 600 to move the float arms between the rigid configuration and the flexible configuration. The lockout system 700 includes a lockout assembly 701 and a lockout tube 704 connected to the lockout assembly 701 such that rotation of the lockout tube 704 in a first direction (indicated by arrow 706) causes the lockout system 700 to lockingly position the float arms 702 into the rigid configuration. Conversely, rotation of the lockout tube 704 in a second direction, opposite the first direction, (indicated by arrow 708) causes the lockout system 700 to move the float arms 702 from the rigid configuration into the flexible configuration.

FIG. 7 is a cross-sectional view and shows additional portions of the example lockout system 700. The lockout system 700 also includes, as part of the lockout assembly 701, a tensioner 710 and a linkage 712 coupled to the lockout tube 704. The tensioner 710 includes a bracket 714, a shaft 716 extending through an aperture 718 in a side 720 of the bracket 722, and a biasing component 724 captured on the shaft 716 between the side 720 of the bracket 714 and a flange 726 secured to the shaft 716. In some implementations, the flange 726 may be secured to the shaft between a shoulder 728 and a nut 730 threadably received onto the shaft 716. In other implementations, the flange 726 may be secured to the shaft 716 in other ways, such as by welding, a press fit, or by being integrally formed onto the shaft 726.

In some implementations, the biasing component 724 is a spring, such as a coil spring. In some implementations, the biasing component 724 is a plurality of biasing components. For example, in some implementations, the biasing component 724 is a plurality of Bellville washers 732 stacked along a length of the shaft 716, as shown in FIG. 7. In some implementations, the Bellville washers 732 are arranged in pairs, such that a base of each Bellville washer 732 in a pair abuts each other. Pairs of the Bellville washers 732 may be arranged adjacent to each other along a length of the shaft 716, as shown, for example, in FIGS. 7 through 10. In some implementations, 32 Bellville washers 732 may be used. However, additional or fewer Bellville washers 732 may be used, and the number of Bellville washers may vary depending upon, for example, sizes and masses of the different components of a header.

In still other implementations, the biasing component 724 may be or include a coil spring. For example, in some instances, the biasing component 724 may include a plurality of coils springs. One or more of the coils springs may be received onto the shaft 716. In still other implementations, the biasing component 724 may be another type of spring. In some implementations, the biasing component 724 is omitted.

The tensioner 710 is pivotably coupled to the float arm 702 by a pin 734 coupled to the float arm 702. In the illustrated example, the pin 734 extends through apertures 736 formed in a clevis 738 that is attached to the float arm 702. The shaft 716 extends through a bore 740 formed through the pin 734. A flange 742 captures the shaft 716 onto the pin 734. In some implementations, the flange 742 may be a washer secured to the shaft 716 between a shoulder 744 and a nut 746 threadably received onto a threaded portion 748 of the shaft 716. In other implementations, the flange 742 may be secured to the shaft 716 in other ways, such as a press fit or welding, or the flange 742 may be integrally formed on the shaft 716. The shaft 716 also includes an enlarged portion 748 that abuts against the side 720 of the bracket 714. Engagement between the side 720 and the enlarged portion 748 allows the biasing component 724 to be preloaded between the side 720 and the flange 726. In some implementations, the biasing component 724 may not be preloaded.

The preload applied to the biasing component 724 may be selected to ensure a force applied to the float arms 702 of a lockout system 700 by the biasing component 724 lifts the float arms 702 into abutting contact between all of the float arms 702 and a portion of a frame of the header, such as a cross tube similar to cross tube 212 shown in FIG. 2. Thus, the preload ensures that a force ultimately provided by the biasing component 724 as the lockout system 700 is moved into the rigid configuration fully actuates all of the float arms 702 notwithstanding any variations in the header, such as manufacturing variations that may otherwise prevent all of the float arms 702 from being in abutting contact with the cross tube when the lockout system 700 is in the rigid configuration. As a result, lockout systems of the present disclosure are operable to ensure full retraction of all of the float arms of a header when placed in the rigid configuration without adjustment during manufacturing or sometime later in the field, such as by a user or technician. Thus, the lockout systems including the biasing component 724 and associated headers of the present disclosure reduce maintenance thereto, improve performance of operation of the headers, increase productivity of the headers, and reduce costs of operation of the headers.

The linkage 712 includes a first link 750 coupled to the lockout tube 704 and a second link 752 pivotably coupled to the first link 750 and the bracket 714. In the illustrated example, the first link 750 is attached to the lockout tube 704 with a fastener 754, such as a bolt. However, in other implementations, the first link 750 may be attached to the lockout tube 704 in other ways, such as by welding, interference fit, an adhesive, or by being integrally formed on the lockout tube 704. Also, in the illustrated example, a nut 756 is used to secure the fastener 754 and the first link 750 to the lockout tube 704.

Referring to FIGS. 7 and 8, the bracket 714 has a general U-shape, and the second link 752 includes a first side 758 and a second side 760. Free ends 762 of the bracket 714 are sandwiched between the first and second sides 758 and 760 at a first end 764 of the second link 752. A tab 766 formed on the first link 750 is disposed between the first and second sides 758 and 760 of the second link 752 at a second end 768 of the second link 752. A pin 770 extends through the first and second sides 758 and 760 at the second end 768 of the second link 752 and the tab 766 of the first link 750 to pivotably couple the first link 750 and the second link 752. A pin 772 extends between the free ends 762 of the bracket 714 and the first and second sides 758 and 760 at the first end 764 of the second link 752 to pivotably couple the second link 752 and the bracket 714. In some implementations, the pins 770 and 772 may be a rod or a fastener, such as a bolt. However, the pins 770 and 772 may have other forms to enable the first link 750 to pivot relative to the second link 752 and the bracket 714 to pivot relative to the second link 752. The float arm 702 is pivotable about a pin 774 that pivotably couples the float arm 702 to a mounting bracket 776. The pin 774 may be, for example, a fastener (e.g., a bolt), a shaft, or other component operable to permit pivoting movement of the float arm 702 relative to the mounting bracket 776. FIG. 8 also shows an impact absorber component 778 that is attached to the frame of the header (such as frame 102 of header 100) and contacts a float arm 702 when retracted into the rigid configuration. The impact absorber component 778 may be attached to the cross tube with fasteners 780, which may be, for example, bolts, pins, or rivets

As shown in FIGS. 7 through 10, the second link 752 has an arcuate shape that provides a relief or recess 782 that receives the lockout tube 704. The recess 782 formed by the arcuate shape receives the lockout tube 704, allowing a centerline 784 of the lockout tube 704 to intersect with centerline 786 of shaft 716, resulting in the elimination of torque in the lockout tube 704, as described in more detail below. The centerline 784 is generally perpendicularly disposed relative to the centerline 786 of the shaft 716. In some instances, the centerlines 784 and 786 may be slightly offset due to slight variations in size of the components, movement of the different components, or variations in components, for example. These slight variations may produce an offset between the centerlines 784 and 786 that, in some cases, may be unavoidable. However, for the purposes of the present disclosure, intersection of the centerlines 784 and 786 is intended to encompass the slight offsets therebetween which may occur.

As shown in FIG. 8, rotation of the lockout tube 704 in the direction of arrow 788 to a first position results in the float arms 702 being placed into a fully retracted position, which corresponds to the rigid configuration of the float arms 702 and cutterbar, such as cutterbar 216. Rotation of the lockout tube 704 in the direction of arrow 790 to a second position results in the float arms 702 being placed in a fully extended position, which corresponds to the flexible configuration of the float arms 702 and cutterbar.

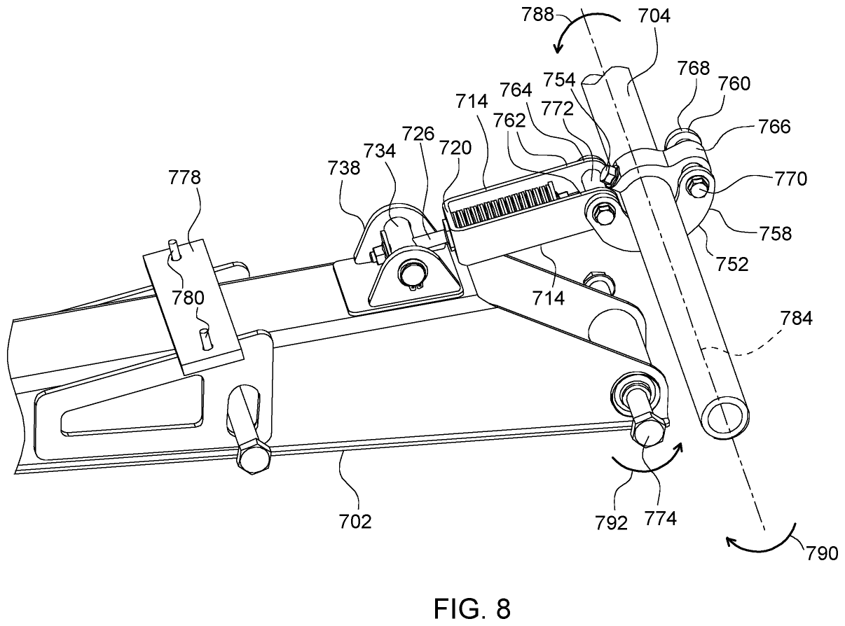

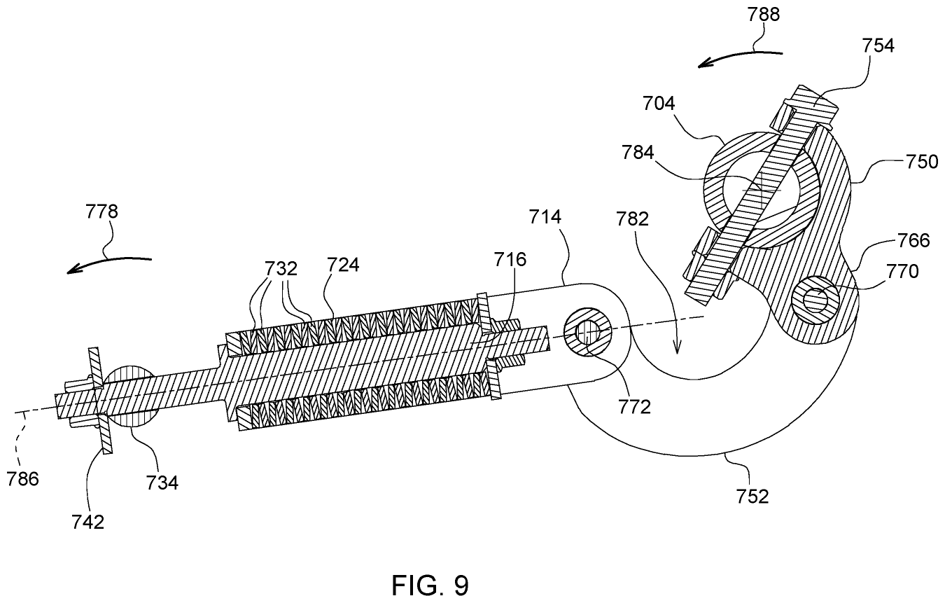

FIGS. 7, 9, and 10 illustrate actuation of the lockout system 700 between the flexible configuration and the rigid configuration. In FIGS. 7 and 9, the lockout system 700 is in the flexible configuration in which the floating arms 702 are in a fully extended position. As a result, the float arms 702 (308) are freely pivotably about pin 774, and each of the float arms 702 coupled to the lockout system 700 are able to pivot independently of the other float arms 702. Although the present example describes a lockout system that can be included on a single wing of a header, in other implementations, a single lockout system operable to position all of the float arms of a header between the flexible configuration and a rigid configuration may be used.

Referring to FIGS. 7 and 9, the lockout tube 704 is angularly oriented in the second position such that the biasing component 724 is unloaded, other than a preload that may be applied to the biasing component 724. With the lockout tube 704 in the second position, the float arms 702 are freely pivotable about the pin 774, allowing the float arms 702 to follow a contour of the ground when the float arms 702 are placed in contact with the ground. As the lockout tube 704 is rotated in the direction of arrow 788, the shaft 716 translates relative to and rotates with the pin 734. As a result, the shaft 716 is both rotated and translated towards the lockout tube 704. As shown in FIG. 6, the shaft 716 is displaced to cause the flange 742 to come into contact with the pin 734. Further rotation of the lockout tube 704 in the direction of arrow 788 results in further displacement and rotation of the shaft 716, which, in turn, causes further compression of the biasing component 724.

With the flange 742 in contact with the pin 734, as the lockout tube 704 continues to be rotated in the direction of arrow 788, the float arm 702 is pivoted about the pin 774 in the direction of arrow 792 (shown in FIG. 8). Moreover, as the shaft 716 is pivoted in the direction of arrow 778, an amount of torque applied to the lockout tube 704 decreases as the centerline 786 of the shaft 716 approaches the centerline 784 (318) of the lockout tube 704 (314).

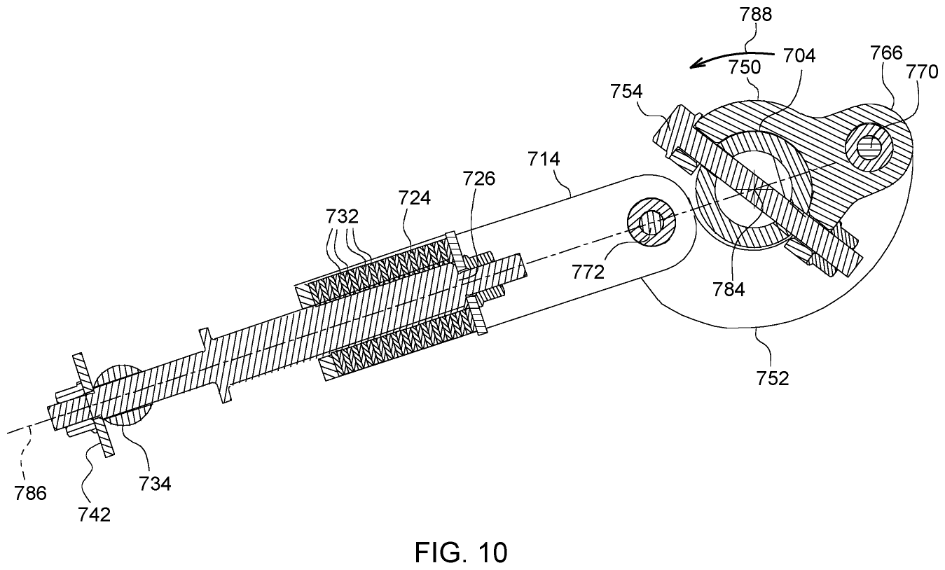

FIG. 10 shows the lockout system 700 in the rigid configuration. As shown in FIG. 10, the lockout tube 704 is moved into the first position. As the lockout tube 704 is moved from the position show in FIG. 9 to the position shown in FIG. 10, the float arms 702 are retracted as a result of the contact between the flange 742 and the pin 734. With the lockout system 700 in the rigid configuration, the float arms 702 are fully retracted and in abutting contact with the cross tube, such as cross-tube 212, or another component of the frame; the lockout tube 704 resides in the curved recess 782 formed by the second link 752; and the centerline 786 of the shaft 716 intersects the centerline 784 of the lockout tube 704. As a result of the intersection of the centerline 786 and the centerline 784, toque applied to the lockout tube 704 is reduced to approximately zero. Further, with the float arms 702 in the rigid configuration, the cutterbar is also placed into a straight and rigid configuration.

With the torque applied to the lockout tube 704 being effectively zero when the float arms 702 are in the retracted and rigid configuration, a size of lockout tube 704 may be reduced, which results in a weight, size, and cost reduction. Additionally, compression of the biasing component 724 provides a force that is sufficient to retract all of the float arms 702 into abutting contact with a component of the frame, such as a cross-tube similar to cross-stube 212, notwithstanding any dimensional variations imparted to the frame during manufacturing, for example. Consequently, the lockout system 700 is operable to actuate all the float arms 702 into contact with a portion of the frame without preliminary adjustment during manufacturing or subsequent adjustment when the header has entered use. Thus, in some implementations, the lockout system 700 avoids an adjustment preformed during manufacturing or sometime thereafter, such as by a technician or user, to ensure full actuation of the float arms 702 into the rigid configuration.

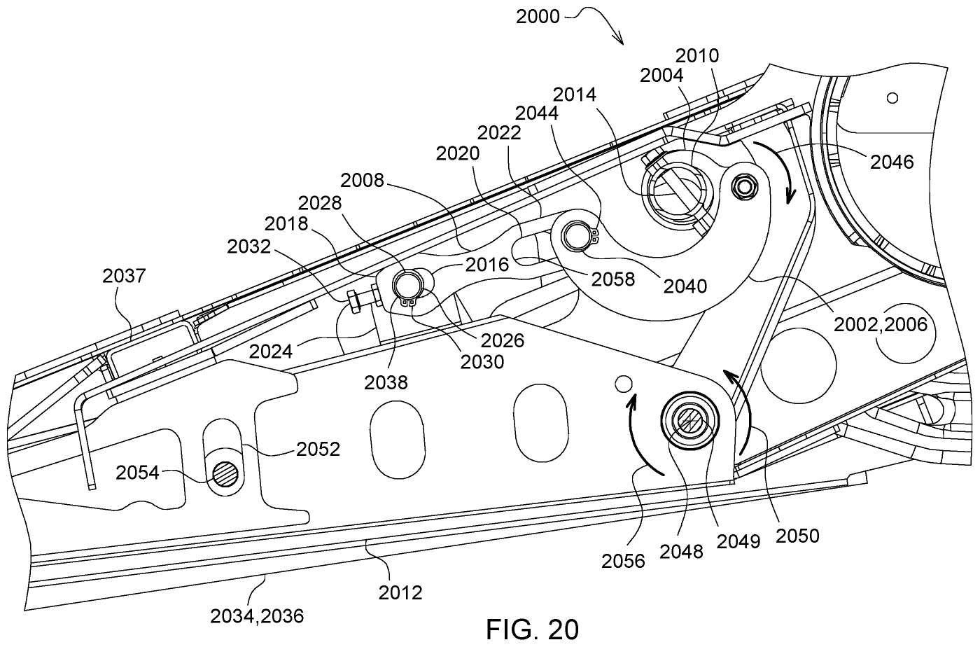

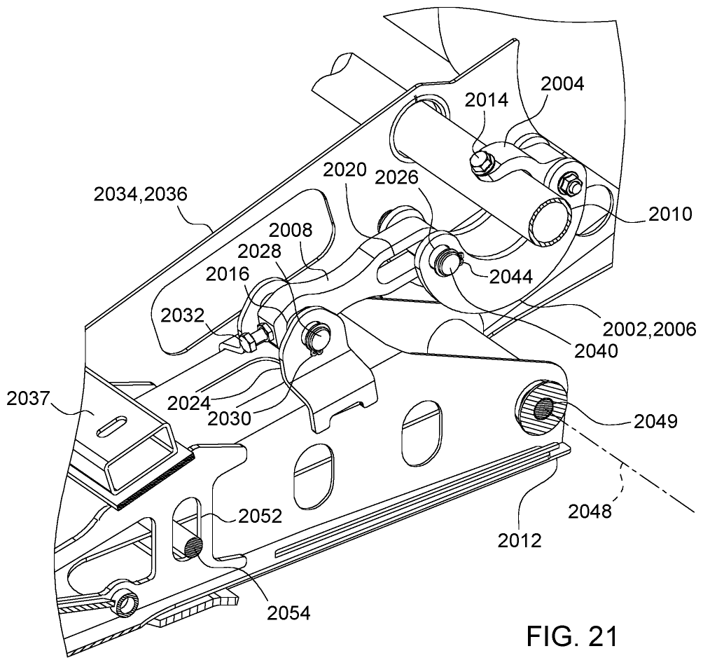

FIGS. 20 and 21 illustrate another example lockout system 2000 operable to move a cutterbar between a flexible configuration and a rigid configuration within the scope of the present disclosure. The example lockout system 2000 is similar to the lockout system 700 except that, in place of the bracket 714, shaft 716, and biasing component 724 are replaced with a third link. Thus, in the lockout system 2000, a linkage 2002 that includes a first link 2004 (similar to first link 750), a second link 2006 (similar to second link 752), and a third link 2008 extends between a shaft 2010 (similar to shaft 704) and a float arm 2012 (similar to float arm 702).

The first link 2004 is fixedly secured to the shaft 2010 in a manner similar to that described above with respect to the first link 750 and shaft 704. For example, in some instances, a fastener 2014, such as a bolt, secures the first link 2004 to the shaft 2010, fixes a location of the first link 2004 relative to the shaft 2010, and prevent relative rotation of the first link 2004 relative to the shaft 2010.

The third link 2008 includes a first slot 2016 at a first end 2018 and a second slot 2020 at a second end 2022. Similar to the float arm 702, the float arm 2012 includes a clevis 2024 defining openings 2026. A pin 2028 extends through the openings 2026 and through the first slot 2016 to secure the third link 2008 to the float arm 2012. In some instances, one or more circlips 2030 pivotably retains the pin 2028 to the float arm 2012. The third link 2008 also includes an adjustor 2032 used to adjust a position of the float arm 2012 relative to a frame 2034 of a header 2036. For example, in the illustrated example, the float arm 2012 abuts a cross tube 2037, similar to the cross tube 212, discussed earlier. In some instances, the adjustor 2032 is a fastener, such as a bolt. Thus, in some instances, rotation of the adjustor 2032 alters an amount by which an end 2038 penetrates the first slot 2016 and, hence, a position at which the end 2038 of the adjustor 2032 engages the pin 2028 within the first slot 2016. As a result, rotation of the adjustor 2032 alters a position at which the pin 2028 resides within the first slot 2016 and a position at which the float arm 2012 engages the frame 2036 when the lockout system 2000 is in the rigid configuration. Thus, the adjustor 2032 provides adjustability that may correct for manufacturing variations.

The second end 2022 is pivotably attached to the second link 2006 with a pin 2040 that extends through the second slot 2020 and openings 2042 in the second link 2006 and is retained, for example, with one or more circlips 2044. FIGS. 20 and 21 illustrate the lockout system 2000 and, hence, the float arm 2012 in the locked configuration. Consequently, a cutterbar coupled to the float arm 2012 is also maintained in the rigid configuration. In this configuration, the pin 2040 is in contact with a proximal end of the second slot 2020. As a result, the pin 2040 is prevented from moving within the second slot 2020 when the lockout system 2000 is in the rigid configuration.

In the flexible configuration, the shaft 2010 is rotated in the direction of arrow 2046, allowing the float arm 2012 to pivot about a pivot axis 2048 in a direction of arrow 2050. In some implementations, an amount by which the float arm 2012 is permitted to pivot in the direction of arrow 2050 is limited by engagement between a slot 2052 formed in the float arm 2012 and a pin 2054 included on the frame 2034. In the flexible configuration, the second slot 2020 permits the float arm 2012 to pivot freely about the pivot axis 2048 (defined by a pin, shaft, or fastener, collectively referred to as “pin” 2049). An amount by which the float arm 2012 is able to pivot freely can be limited by a size of the slot 2020. Particularly, an amount by which the float arm 2012 is permitted to pivot in a direction of arrow 2056 is limited when the pin 2040 engages a proximal end 2058 of the second slot 2020.

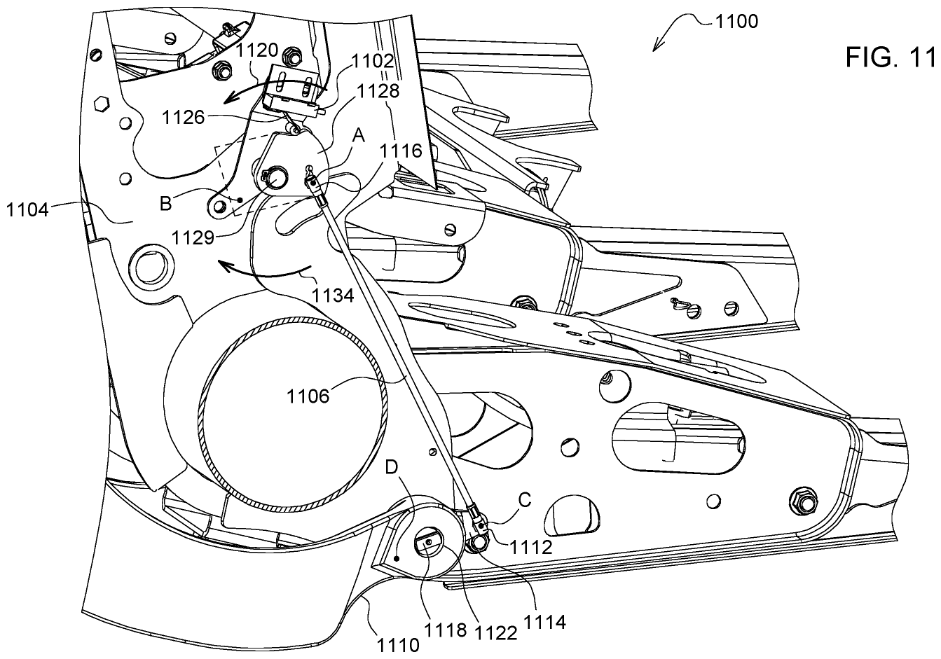

FIGS. 11 through 14 illustrate an example system 1100 for automatically configuring a cutterbar of a header. The system 1100 includes a sensor 1102 affixed to a header 1104. A rod or shaft or link (collectively referred to a “rod” 1106) extends between a gauge wheel and the sensor 1102. Particularly, the rod 1106 is pivotably connected to a gauge wheel arm 1110 to which the gauge wheel is pivotably attached, an example of which is illustrated in FIG. 6. In the illustrated example, a first end 1112 of the rod 1106 extends from a protrusion 1114 formed on the gauge wheel arm 1110. The rod 1106 is pivotably attached to the protrusion 1114. A second end 1116 of the rod 1106 is pivotably connected to the sensor 1102 and particularly to a rotor 1128 of the sensor 1102.

As the gauge wheel 1108 extends, the gauge wheel arm 1110 rotates about an axis 1118 in the direction of arrow 1120 (a counterclockwise direction in the context of FIGS. 11 through 14). The axis 1118 is defined by a pin or shaft 1122 that connects the gauge wheel 1108 to the gauge wheel arm 1110. Extension of the gauge wheel is detected by the sensor 1102. For example, the sensor 1102 includes an electrical switch 1124 having an arm 1126 and the rotor 1128. The second end 1116 of the rod 1106 is pivotably attached to the rotor 1128. The rotor 1128 includes a profiled surface 1130 on which the arm 1126 follows. As already mentioned, as the gauge wheel extends, the gauge wheel arm 1110 rotates in the direction of arrow 1120. This rotational movement of the gauge wheel arm 1110 is transmitted to the rotor 1128 of the sensor 1102 via the rod 1106. In response, the rotor 1128 also rotates in the direction of arrow 1120.

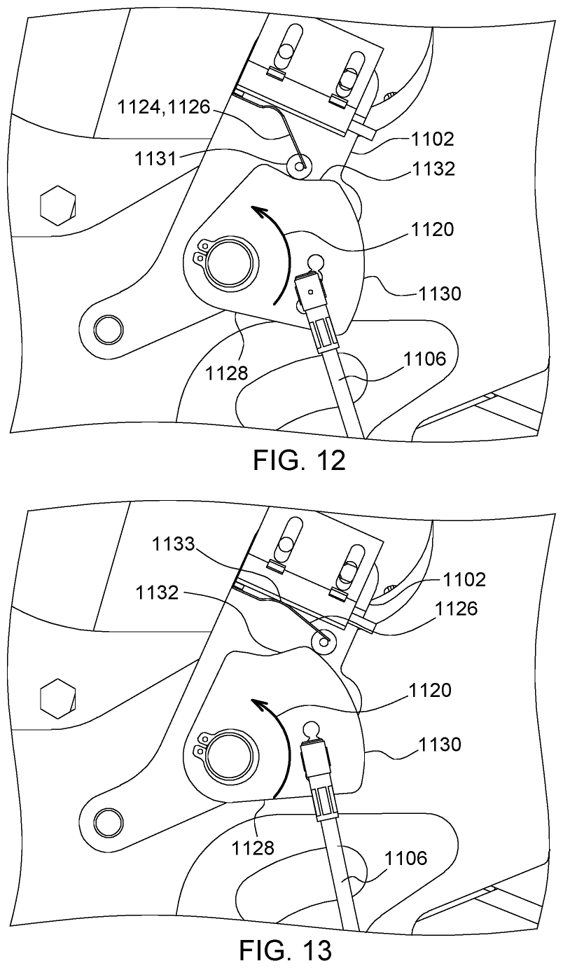

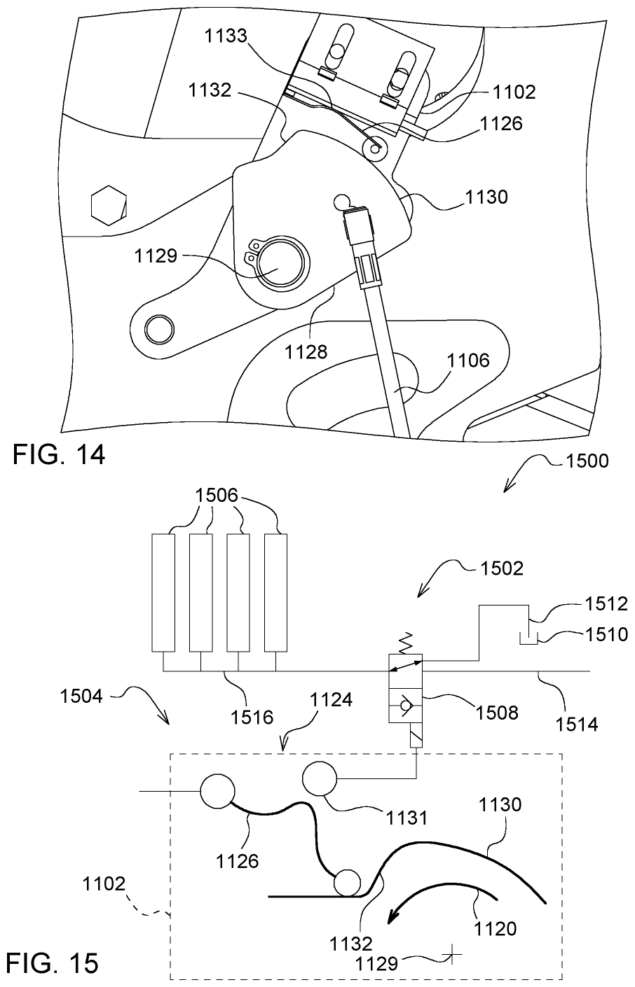

FIG. 12 is a detail view of the sensor 1102 with the gauge wheel 1108 in the fully retracted position. With the gauge wheel fully retracted, the arm 1126 of the sensor 1102 is extended so as to form an open electrical circuit. As the rotor 1128 rotates about an axis 1129 in the direction of arrow 1120, the arm 1126 follows the profile of surface 1130. In some implementations, the arm 1126 may include a follower 1131 (e.g., a roller pivotably attached to the arm 1126) that follows the profile of surface 1130. At a selected amount of extension of the gauge wheel, such a 10% of full extension of the gauge wheel, the profile of the surface 1130 causes the arm 1126 to flex or pivot to make contact with another portion 1133 of the sensor 1102, thereby forming a closed electrical circuit. Although 10% of full extension is disclosed, the amount of extension of the gauge wheel may be any desired amount. FIG. 13 shows that the profile of surface 1130 includes a ramp 1132, and as the arm 1126 engages the ramp 1132, the arm pivots or flexes to cause displacement of the arm 1126 and contact with the portion 1133 of the senor 1102 to form the closed electrical circuit. Formation of the closed electrical circuit causes the cutterbar of the header, such as cutterbar 132, 314, 508, or other cutterbar within the scope of the present disclosure, to move into the rigid configuration. As the gauge wheel continues to extend, the profile of the surface 1130 is such that the arm 1126 maintains contact with the portion 1133 of the sensor to maintain the closed electrical circuit, as shown in FIG. 14. Thus, in some implementations, the sensor 1102 includes an electrical switch 1124 that is movable between an open circuit and a closed circuit to indicate a position of the gauge wheel.

FIG. 15 is a schematic of an example system 1500 that operates to move the cutterbar between the fixed configuration and the flexible configuration by moving the float arms of the header between the fixed configuration and the flexible configuration. The system 1500 includes a hydraulic circuit 1502 and an electrical circuit 1504. In the example implementation illustrated in FIG. 15, the hydraulic circuit 1502 is operated in response to operation of the electrical circuit 1504. Although a hydraulic circuit is described, in other implementations, a pneumatic circuit, an electrical circuit, or other type of system may also be employed with or in place of the hydraulic circuit to move the cutterbar between the flexible configuration and the fixed configuration in response to detection of movement of a gauge wheel by a sensor, such as sensor 1102. For example, in place of a hydraulic circuit that includes one or more hydraulic actuators (e.g., one or more hydraulic cylinders), one or more pneumatic actuators (e.g., one or more pneumatic cylinders) or one or more electrical actuators (e.g., one or more electrical linear actuators) may be used. Actuators other than linear actuators, such as rotary actuators, may also be used.

The hydraulic circuit 1502 includes a plurality of hydraulic actuators 1506 that are coupled to associated float arms of the header. A two-way, solenoid-operated valve 1508 is used to control fluid flow to and from the hydraulic actuators 1506. Other types of valves may be used in other implementations, such as a three-way, solenoid-operated valve. In a default or unenergized condition (referred to hereinafter as a “first position”), the valve 1508 provides fluid communication between the hydraulic actuators 1506 and a fluid reservoir 1510 or another location, via a line 1512, to drain pressurized hydraulic fluid from the hydraulic actuators 1506. Thus, with the valve 1508 in the first position, the hydraulic actuators 1506 are retracted. In an energized condition (referred to hereinafter as a “second position”), the valve 1508 provides fluid communication between the hydraulic actuators 1506 and a source of pressurized fluid via a line 1514. With the valve 1508 in the second position, pressurized hydraulic fluid provided to the hydraulic actuators 1506 causes the hydraulic actuators 1506 to extend.

Regarding the electrical circuit 1504, as the rotor 1128 is pivoted about axis 1129 in the direction of arrow 1120 in response to extension of the gauge wheel, as explained above, the arm 1126 of the sensor 1102 follows the surface 1130. When the arm 1126 encounters the ramp 1132 of the surface and is pivoted or flexed in response, the arm 1126 contacts the portion 1133 of the sensor 1102 to form a closed electrical circuit of the electrical switch 1124. When the electrical circuit closes, electrical power is provided to the valve 1508, moving the valve 1508 from the first position to the second position. In the second position, pressurized hydraulic fluid is passed from line 1514, through valve 1508, and into line 1516 wherein the pressurized hydraulic fluid is distributed to the hydraulic actuators 1506. In response, the hydraulic actuators 1506 extend, which moves the float arms from the flexible configuration to the rigid configuration. Consequently, the cutterbar is moved from the flexible configuration to the rigid configuration. Thus, the sensor 1102 senses movement of the gauge wheel to change correspondingly and automatically the configuration of the cutterbar.

Retraction of the gauge wheel 1108 similarly causes automatic movement of the cutterbar from the rigid configuration to the flexible configuration. Retraction of the gauge wheel 1108 causes rotation of the rotor 1130 in a direction opposite that of arrow 1120, which opens the electrical circuit. In response, the valve 1508 moves from the second position to the first position, allowing the pressurized fluid to drain from the hydraulic actuators 1506, through the valve 1508 and line 1512, and into the reservoir 1510 or elsewhere. With the pressurized hydraulic fluid removed from the hydraulic actuators 1506, the hydraulic actuators 1506 retract, moving the cutterbar from the rigid configuration to the flexible configuration. Thus, both extension and retraction of the gauge wheel 1108 automatically causes a change in configuration of the cutterbar.

Although a plurality of hydraulic actuator 1506 are included in the example of FIG. 15, in other implementations, a single hydraulic actuator (or other type of actuator as described earlier) may be used. For example, a single actuator may be used to move the cutterbar between the flexible configuration and the rigid configuration. For example, an implementation as described above in the context of FIGS. 6 through 10 may include a single actuator that, in combination with a lockout system, such as the lockout system 700 or lockout system 2000, described earlier, moves the cutterbar between the flexible configuration and the rigid configuration.

Further, the scope of the present disclosure is not limited to the example described in the context of FIGS. 11 through 14. Referring to FIG. 11, locations A and B and C and D are identified. To accommodate location B, a size of the rotor 1128 may be altered, as indicated by the dotted lines. In the illustrated example, the rod 1106 extends between point A on the rotor 1128 and location C provided on the tab 1114 of the arm 1110. However, in other implementations, the rod 1106 may extend between location A and location D, which is located on the arm 1110 on an opposite side of the axis 1118 compared to location C. As a result, extension of the gauge wheel arm 1110 (and, accordingly, the associated gauge wheel) causes rotation of rotor 1128 in the direction of arrow 1134. In some cases, the rod 1106 extends between locations B and D. In this configuration, extension of the gauge wheel arm 1110 and associated gauge wheel also causes rotation of the rotor 1128 in the direction of arrow 1120. Further, in some instances, the rod 1106 extends between locations B and C. Location B is provided on the rotor 1128 on an opposite side of axis 1129. In these instances, extension of the gauge wheel arm 1110 and associated gauge wheel causes rotation of the rotor 1128 in the direction of arrow 1134. Retraction of the gauge wheel arm 1110 causes rotation of the rotor 1128 in the opposite rotational direction as that associated with extension of the gauge wheel arm 1110.

In each of these iterations, a size and shape of the rotor 1128 may be altered, the profile of surface 1130 may be altered, and a configuration of the arm 1126 may be changed so that rotation of the rotor 1128 in the described rotational direction maintains actuation of the cutterbar as described herein, e.g., moving the cutterbar into the rigid configuration in response to extension of one or more gauge wheels.

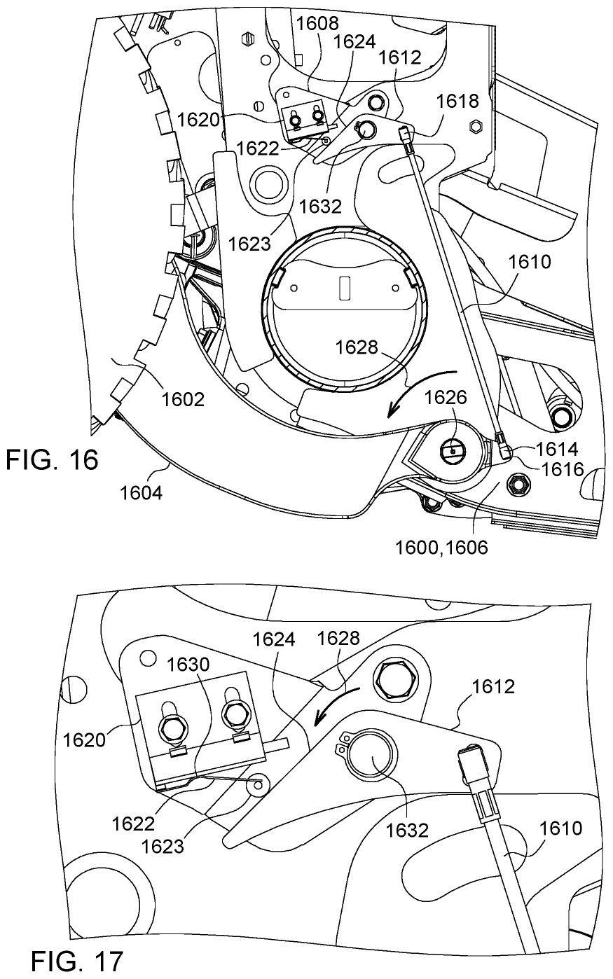

FIGS. 11 through 15 illustrate extension of a gauge wheel closes and electrical circuit to cause movement of a cutterbar from a flexible configuration to a rigid configuration. In other implementations, moving a cutterbar from a flexible configuration to a rigid configuration is associated with opening of an electrical circuit in response to extension of a gauge wheel. FIGS. 16 through 19 illustrates such an example.

FIG. 16 shows an example header 1600 that includes a gauge wheel 1602 pivotable attached to a gauge wheel arm 1604. The gauge wheel arm 1604 is pivotably connected to a frame 1606 of the header 1600. A sensor 1608 is provided on the header 1600 with a rod 1610 extending between the gauge wheel arm 1604 and a rotor 1612 of the sensor 1608. A first end 1614 of the rod 1610 is pivotably connected to a tab 1616 formed on the gauge wheel arm 1604. A second end 1618 of the rod 1610 is pivotably connected to the rotor 1612. The sensor 1608 also includes an electric switch 1620 that includes an arm 1622 that follows along a surface 1624 of the rotor 1612. The arm 1622 may include a follower 1623 (e.g., a roller) to follow along the surface 1624. Here, though, with the gauge wheel 1602 (and gauge wheel arm 1604) in the retracted position, the electric switch 1620 forms a closed electrical circuit. The closed electrical circuit maintains the cutterbar of the header 1600 in the flexible configuration, as described below. Extension of the gauge wheel 1602 and gauge wheel arm 1604 causes rotation of the gauge wheel 1602 and gauge wheel arm 1604 about axis 1626 in the direction of arrow 1628 (counterclockwise in the context of FIG. 16). Rotational motion of the gauge wheel 1602 and gauge wheel arm 1604 is transferred to the rotor 1612 via the rod 1610. In response, the rotor 1612 is also rotated in the direction of arrow 1628 about axis 1632.

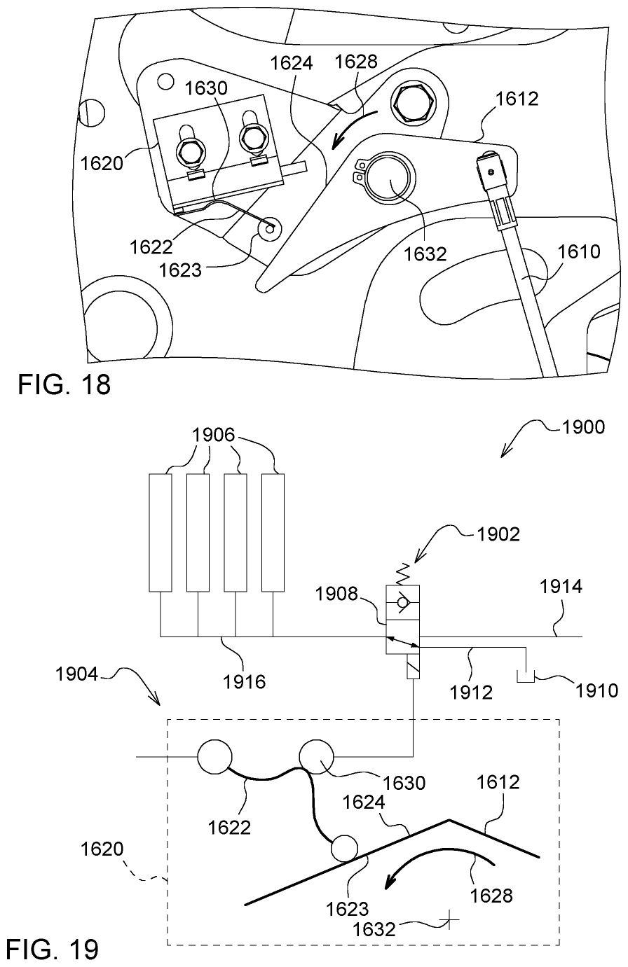

FIG. 17 shows the arm 1622 engaged with the surface 1624 of the rotor 1612. As the rotor 1612 rotates about axis 1632 in the direction of arrow 1628, the surface 1624 on which the arm 1622 is in contact moves away from the arm 1622, causing the arm 1622 to move away from another portion 1630 of the switch 1620 in which the arm 1622 is in contact to form the closed electrical circuit. In some implementations, the arm 1622 is biased in a direction away from the portion 1630 of the switch 1620. For example, the arm 1622 may be spring loaded or may move away from the portion 1630 by relaxation of the arm 1622 from a flexed condition. Separation from the arm 1622 from the surface 1624 forms an open electrical circuit (shown in FIG. 18), causing actuation of the cutterbar from the flexible configuration to the rigid configuration, as described in more detail below.

Although FIGS. 16 through 18 illustrate one example configuration of the header 1600, the scope of the present disclosure is broader. For example, as explained above in the context of FIG. 12, locations at which the rod 1610 is coupled to the gauge wheel arm 1604 and the rotor 1612 can be altered (e.g., locations similar to locations A, B, C, and D shown in FIG. 12). In doing so, a rotational direction in which the rotor 1612 is made to move in response to extension of the gauge wheel arm 1604 can be changed. Also similarly, in each iteration, a size and shape of the rotor 1612 may be altered, the profile of surface 1624 may be altered, and a configuration of the arm 1622 may be changed so that rotation of the rotor 1612 in the respective rotational direction maintains actuation of the cutterbar as described herein, e.g., moving the cutterbar into the rigid configuration in response to extension of one or more gauge wheels.

FIG. 19 is a schematic view of an example system 1900 that operates to move the cutterbar between the fixed configuration and the flexible configuration by moving the float arms of the header between the fixed configuration and the flexible configuration. The system 1900 includes a hydraulic circuit 1902 and an electrical circuit 1904. In the example implementation illustrated in FIG. 19, the hydraulic circuit 1902 is operated in response to operation of the electrical circuit 1904. Although a hydraulic circuit is described, in other implementations, a pneumatic circuit, an electrical circuit, or other type of system may also be employed with or in place of the hydraulic circuit to move the cutterbar between the flexible configuration and the fixed configuration in response to detection of movement of a gauge wheel, such as gauge wheel 1602, by a sensor, such as sensor 1608. For example, in place of a hydraulic circuit that includes one or more hydraulic actuators (e.g., one or more hydraulic cylinders), one or more pneumatic actuators (e.g., one or more pneumatic cylinders) or one or more electrical actuators (e.g., one or more electrical linear actuators) may be used. Actuators other than linear actuators, such as rotary actuators, may also be used.

The hydraulic circuit 1902 includes a plurality of hydraulic actuators 1906 that are coupled to associated float arms of the header. A two-way, solenoid-operated valve 1908 is used to control fluid flow to and from the hydraulic actuators 1906. Other types of valves may be used in other implementations, such as a three-way, solenoid-operated valve. In a default or energized condition (referred to hereinafter as a “first position”), the valve 1908 provides fluid communication between the hydraulic actuators 1906 and a fluid reservoir 1910 or another location, via a line 1912, to drain pressurized hydraulic fluid from the hydraulic actuators 1906. Thus, with the valve 1908 in the first position, the hydraulic actuators 1906 are retracted. In an unenergized condition (referred to hereinafter as a “second position”), the valve 1908 provides fluid communication between the hydraulic actuators 1906 and a source of pressurized fluid via a line 1914. With the valve 1908 in the second position, pressurized hydraulic fluid provided to the hydraulic actuators 1906 causes the hydraulic actuators 1906 to extend.

Although a plurality of hydraulic actuators 1906 is included in the example of FIG. 19, in other implementations, a single hydraulic actuator (or other type of actuator as described earlier) may be used. For example, a single actuator may be used to move the cutterbar between the flexible configuration and the rigid configuration. For example, an implementation as described above in the context of FIGS. 6 through 10 may include a single actuator that, in combination with a lockout system, such as the lockout system 700 or lockout system 2000, described earlier, moves the cutterbar between the flexible configuration and the rigid configuration.

Regarding the electrical circuit 1904, when the gauge wheel 1602 and gauge wheel arm 1604 are in the retracted position, the arm 1622 of the switch 1620 maintains a closed electrical circuit due to engagement between the arm 1622 and the surface 1624 of the rotor 1612. With the gauge wheel 1602 and gauge wheel arm 1604 in the retracted position, the rotor 1612 is positioned such that the arm 1622 of the switch 1620 is deflected so as to contact the portion 1630 to form the closed electrical circuit. As the gauge wheel 1602 and gauge wheel arm 1604 are extended, the rod 1610 transfers the rotational motion of the gauge wheel arm 1604 to cause rotation of the rotor 1612. In this example, the rotor 1612 rotates in the direction of arrow 1628 about axis 1632, as shown in FIG. 16.

As the rotor 1612 is pivoted about axis 1630 in the direction of arrow 1628 in response to extension of the gauge wheel 1602, as explained above, the rotor 1612 moves away from the arm 1622. In some implementations, for a portion of the rotation of the rotor 1612, the arm 1622 maintains contact with portion 1630 as the distortion of the arm 1622 relaxes (in the case where the arm 1622 flexes). At some point during rotation of the rotor 1612 in the direction of arrow 1628 (e.g., when the gauge wheel 1602 has been extend approximately 10% of full extension of the gauge wheel 1602), engagement between the rotor 1612 and the arm 1622 ceases, and the arm 1622 moves out of contact with the portion 1630 of the switch 1620. In other implementations, the amount of extension of the gauge wheel may be any desired amount of extension. As a result, the switch 1620 forms an open electrical circuit.

The valve 1908 operates in response to the switch 1620. In response to the open electrical circuit, the valve 1908 moves from the first position to the second position where pressurized hydraulic fluid is passed from line 1914, through valve 1908, and into line 1916 wherein the pressurized hydraulic fluid is distributed to the hydraulic actuators 1906. In response, the hydraulic actuators 1906 extend, which moves the float arms from the flexible configuration to the rigid configuration. Consequently, the cutterbar is moved from the flexible configuration to the rigid configuration. Thus, the sensor 1620 senses movement of the gauge wheel to change correspondingly and automatically the configuration of the cutterbar.

Retraction of the gauge wheel 1602 similarly causes automatic movement of the cutterbar from the rigid configuration to the flexible configuration. Retraction of the gauge wheel 1602 causes rotation of the rotor 1612 in a direction opposite that of arrow 1628, which closes the electrical circuit. In response, the valve 1908 moves from the second position to the first position, allowing the pressurized fluid to drain from the hydraulic actuators 1906, through the valve 1908 and line 1912, and into the reservoir 1910 or elsewhere. With the pressurized hydraulic fluid removed from the hydraulic actuators 1906, the hydraulic actuators 1906 retract, moving the cutterbar from the rigid configuration to the flexible configuration. Thus, both extension and retraction of the gauge wheel 1602 automatically causes a change in configuration of the cutterbar.

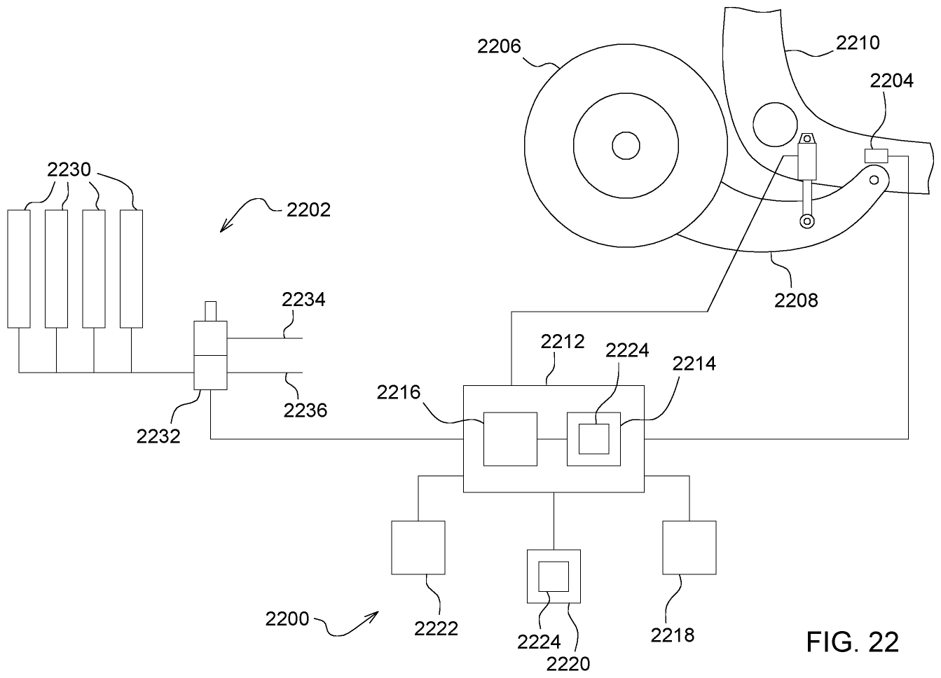

FIG. 22 is a schematic view of another example control system 2200 for automatically actuating a cutterbar between a rigid configuration and a flexible configuration in response to sensed movement of a gauge wheel. The example system 2200 incorporates a fluidic circuit 2202 that may be similar to the fluidic circuit 1502 or fluidic circuit 1902. Other types of circuits may also be used and are within the scope of the present disclosure. Further, in some implementations, the fluidic circuit 2202 is replaced with another type of circuit to actuate cutterbar between the flexible configuration and the rigid configuration. For example, in some implementations, the fluidic circuit is replaced with an electrical circuit that, for example, actuators one or more electrical actuators, such as electrical linear actuators or electrical rotary actuators. Thus, the scope of the present disclosure is not limited to systems that include a fluidic circuit but, rather, encompass other types of power systems to actuator the cutterbar.

The control system 2200 also includes a sensor 2204 that senses a position or movement of a gauge wheel 2206 or gauge wheel arm 2208 of an agricultural header 2210. Example sensors 2204 include rotary position sensors, magnetic position sensors, proximity sensors, and laser sensors. Other types of sensors that detect a change in motion or position could also be used. The sensor 2204 is in communication, either via wired connection or a wireless connection, to an electronic controller 2212. The controller 2212 includes a processor 2214 communicably coupled to a memory 2216. The control system 2200 also includes an input device 2218 a display 2220, and a database 2222. The illustrated control system 2200 is provided merely as an example. One or more components or features of the example control system 2200 may be omitted or one or more components or features may be added and still remain within the scope of the present disclosure. For example, in some instances, the display 2220 or database 2222 may be omitted.

In some implementations, the controller 2212 is a computer system, such as computer system 2400 described in more detail below. Additional details of the controller 2212, such as processor 2214 and memory 2216, are described below in the context of computer system 2400. The memory 2216 communicates with the processor 2214 and is used to store programs and other software, information, and data. The processor 2214 is operable to execute programs and software and receive information from and send information to the memory 2216. Although a single memory 2216 and a single processor 2214 are illustrated, in other implementations, a plurality of memories, processors, or both may be used. Although the processor 2214 and the memory 2216 are shown as being local components of the controller 2212, in other implementations, one or both of the processor 2214 and memory 2216 may be located remotely. Software 2224, such as in the form of an application or program, is executed by the processor 2214 to control operation of the control system 2200, as described in more detail below.

The input device 2218 is communicably coupled via a wired or wireless connection. Example input devices 2218 include a keyboard, keypad, one or more buttons, a slider bar, a dial, a knob, a mouse, or a joystick. The display 2220 is communicably coupled to the controller 2212 via a wired or wireless connection. The display 2220 displays information, such as information related to the operation of control system 2200. For example, information displayed by the display 2220 may include a current position of the gauge wheel 2206 or gauge wheel arm 2208 along a range of motion of the gauge wheel 2206 or gauge wheel arm 2208, a condition of a cutterbar of the header 2210 (e.g., whether the cutterbar is in the flexible configuration or the rigid configuration), or a position of one or more actuators of the fluidic circuit 2202. In some instances, the information displayed by the display 2220 is displayed via a graphical user interface (GUI) 2224. Example displays include cathode ray tubes (CRT), liquid crystal displays (LCDs), or plasma displays. Other types of displays are also within the scope of the present disclosure. In some implementations, the display 2220 is a touch screen that is operable to receive input from a user via a user's touch. In some implementations in which the display 2220 is a touch screen, the input device 2218 is omitted.

The fluidic circuit 2202 of the control system 2200 includes a plurality of fluidic actuators 2230. In some implementations, the plurality of fluidic actuators 2230 are coupled to a plurality of float arms to move the float arms between the rigid configuration and the flexible configuration and, consequently, move the cutterbar of the agricultural header 2210 between the rigid configuration and the flexible configuration. For example, in some implementations, each of the actuators 2230 is operatively connected to a respective float arm of the agricultural header 2210. In other implementations, the fluidic circuit 2202 includes a single fluidic actuators 2230 and is coupled to a lockout system, such as lockout system 700 or 2000. Actuation of the single fluidic actuator 2230 operates to actuate the cutter bar between the flexible configuration and the rigid configuration as described herein. In other implementations, more than one fluidic actuator 2230 can be used in combination with a lockout system as described herein, such as lockout system 700 or lockout system 2000.

The fluidic circuit 2202 also includes a movable valve 2232. In some implementations, the valve 2232 may be solenoid operated valve similar to valves 1508 or 1908. In other implementations, other types of valves may be used. The valve 2232 is moveable between a first position in which pressurized fluid is introduced to the fluidic actuators 2230 from a line 2234, causing extension of the fluidic actuators 2230, and a second position in which pressurized fluid is released from the fluidic actuators 2230 via line 2236, causing retraction of the fluidic actuators 2230.

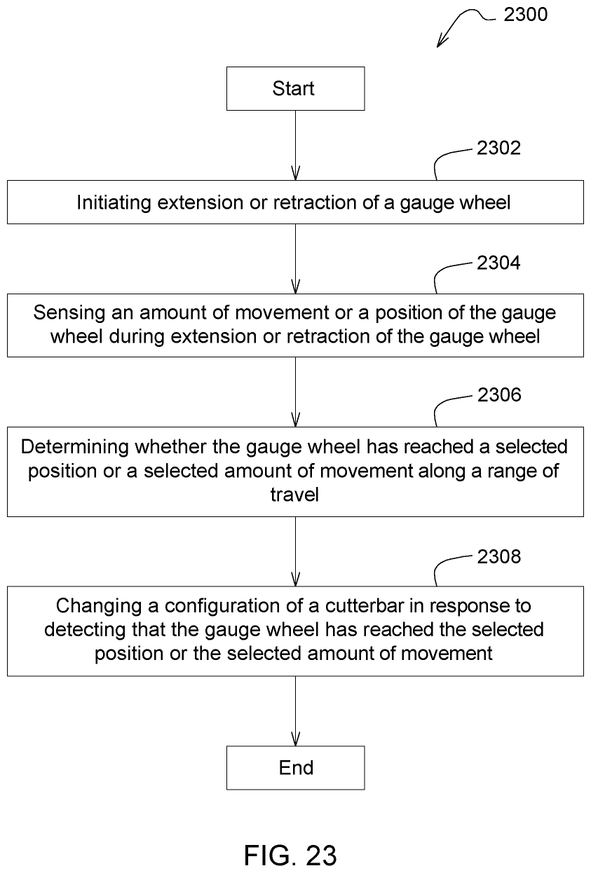

FIG. 23 is a flowchart of an example method 2300 of automatically moving a cutterbar of an agricultural header, such as agricultural header 600, 1104, 1600, 2036, or 2210. For the purpose of the description of FIG. 23, example agricultural header 2210 is referenced. However, the scope of the disclose is not so limited.

In operation, at 2302, a user, such as an operator of an agricultural vehicle to which the header 2210 is attached, initiates one of extension or retraction of the gauge wheel 2206. For example, during extension of the gauge wheel 2206, the user may interact with the input device 2218 or the GUI 2226. In response to the input from the user, the controller 2212 causes actuation of an actuator 2228 of the header 2210. For example, the controller 2212 may generate a control signal that initiates extension or retraction of the gauge wheel 2206. In some implementations, actuation of the actuator 2228 may include directing pressurized fluid to or draining pressurized fluid away from the actuator 2228 to cause the actuators 2228 to one of extend or retract the gauge wheel 2206. In other implementations, actuating the actuator 2228 may include applying electrical power to the actuator 2228 to cause the actuator 2228 to extend or retract. Other types of actuators (e.g., pneumatically powered actuators) and other types of power sources (e.g., pneumatic pressure) may be used to operate the actuator 2228. Example actuators 2228 include linear actuators, rotary actuators, and other types of actuators.

At 2304, motion or a position of the gauge wheel 2206 is sensed by a sensor, such as sensor 2204. In some implementations, motion or a position of the gauge wheel 2206 is sensed along a range of motion traveled by the gauge wheel 2206, such as the range of travel between a fully extended position and a fully retracted position, is sensed. The sensed motion or position of the gauge wheel 2206 is sent to the controller 2212. At 2306, a determination is made as to whether the gauge wheel 2206 has reached a selected position or amount of movement along the range of travel. For example, during extension of the gauge wheel 2206, the controller 2212 determines whether the gauge wheel 2206 has reached as selected position or whether a selected amount of movement of the gauge wheel 2206 has occurred. At 2308, when a selected amount of movement or a selected position of the gauge wheel 2206 has been reached, a change in configuration of the cutterbar of the header 2210 is made. For example, when the gauge wheel 2206 reaches a selected amount of movement or reaches a selected position, the controller 2212 generates and sends a signal to cause the hydraulic circuit 2202 actuate the one or more actuators 2230. For example, the selected position of the gauge wheel 2206 may be a position within a range of 10% to 20% of full extension of the gauge wheels. However, the selected position may be any desired position. In another example, the selected position of the gauge wheel 2206 may be a position within 80% to 90% of full retraction of the gauge wheel. Again, though, the selected position may be any desired position. Further, for example, during extension of the gauge wheel 2206, when the gauge wheel 2206 reaches a selected position or reaches a selected amount of movement, the controller 2212 signals the valve 2232 to cause the valve 2232 to introduce pressurized fluid to the one or more actuators 2230. As a result, the cutterbar is automatically moved from the flexible configuration to the rigid configuration. For example, the cutterbar is moved from the flexible configuration in which the float arms of the agricultural header 2210 are freely pivotable to the rigid configuration in which the float arms are in a fixed condition. During retraction of the gauge wheel 2206, when the gauge wheel 2206 reaches a selected position or reaches a selected amount of movement, the controller signals the valve to causes the valve 2232 to release the pressurized fluid from the actuators 2230. As a result, the cutterbar is automatically moved from the rigid configuration to the flexible configuration. For example, the cutterbar is moved from the rigid configuration in which the float arms of the agricultural header 2210 are in the fixed condition to the rigid configuration in which the float arms are freely pivotable.

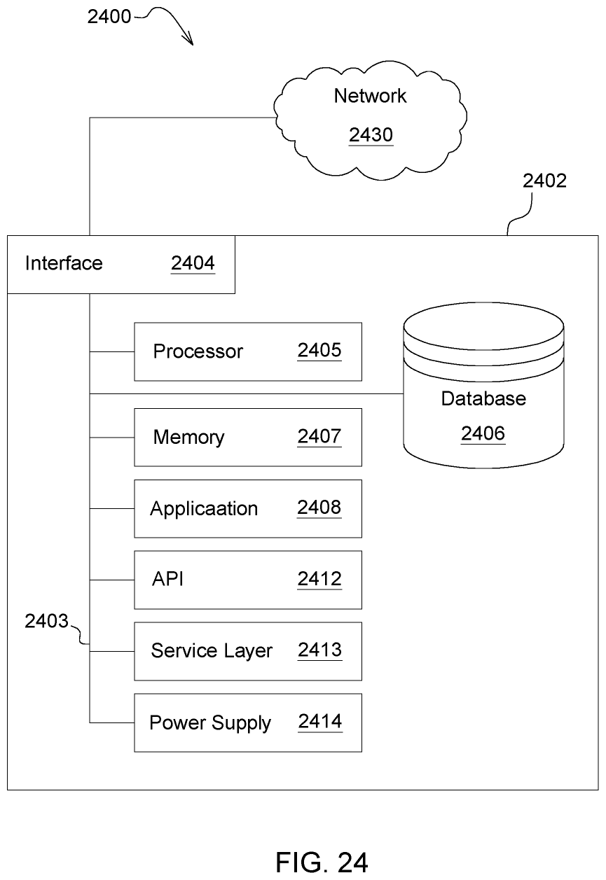

FIG. 24 is a block diagram of an example computer system 2400 used to provide computational functionalities associated with described algorithms, methods, functions, processes, flows, and procedures described in the present disclosure, according to some implementations of the present disclosure. The illustrated computer 2402 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 2402 can include input devices such as keypads, keyboards, and touch screens that can accept user information. Also, the computer 2402 can include output devices that can convey information associated with the operation of the computer 2402. The information can include digital data, visual data, audio information, or a combination of information. The information can be presented in a graphical user interface (UI) (or GUI).

The computer 2402 can serve in a role as a client, a network component, a server, a database, a persistency, or components of a computer system for performing the subject matter described in the present disclosure. The illustrated computer 2402 is communicably coupled with a network 2430. In some implementations, one or more components of the computer 2402 can be configured to operate within different environments, including cloud-computing-based environments, local environments, global environments, and combinations of environments.

At a high level, the computer 2402 is an electronic computing device operable to receive, transmit, process, store, and manage data and information associated with the described subject matter. According to some implementations, the computer 2402 can also include, or be communicably coupled with, an application server, an email server, a web server, a caching server, a streaming data server, or a combination of servers.

The computer 2402 can receive requests over network 2430 from a client application (for example, executing on another computer 2402). The computer 2402 can respond to the received requests by processing the received requests using software applications. Requests can also be sent to the computer 2402 from internal users (for example, from a command console), external (or third) parties, automated applications, entities, individuals, systems, and computers.

Each of the components of the computer 2402 can communicate using a system bus 2403. In some implementations, any or all of the components of the computer 2402, including hardware or software components, can interface with each other or the interface 2404 (or a combination of both), over the system bus 2403. Interfaces can use an application programming interface (API) 2412, a service layer 2413, or a combination of the API 2412 and service layer 2413. The API 2412 can include specifications for routines, data structures, and object classes. The API 2412 can be either computer-language independent or dependent. The API 2412 can refer to a complete interface, a single function, or a set of APIs.

The service layer 2413 can provide software services to the computer 2402 and other components (whether illustrated or not) that are communicably coupled to the computer 2402. The functionality of the computer 2402 can be accessible for all service consumers using this service layer. Software services, such as those provided by the service layer 2413, can provide reusable, defined functionalities through a defined interface. For example, the interface can be software written in JAVA, C++, or a language providing data in extensible markup language (XML) format. While illustrated as an integrated component of the computer 2402, in alternative implementations, the API 2412 or the service layer 2413 can be stand-alone components in relation to other components of the computer 2402 and other components communicably coupled to the computer 2402. Moreover, any or all parts of the API 2412 or the service layer 2413 can be implemented as child or sub-modules of another software module, enterprise application, or hardware module without departing from the scope of the present disclosure.

The computer 2402 includes an interface 2404. Although illustrated as a single interface 2404 in FIG. 24, two or more interfaces 2404 can be used according to particular needs, desires, or particular implementations of the computer 2402 and the described functionality. The interface 2404 can be used by the computer 2402 for communicating with other systems that are connected to the network 2430 (whether illustrated or not) in a distributed environment. Generally, the interface 2404 can include, or be implemented using, logic encoded in software or hardware (or a combination of software and hardware) operable to communicate with the network 2430. More specifically, the interface 2404 can include software supporting one or more communication protocols associated with communications. As such, the network 2430 or the interface's hardware can be operable to communicate physical signals within and outside of the illustrated computer 2402.

The computer 2402 includes a processor 2405. Although illustrated as a single processor 2405 in FIG. 24, two or more processors 2405 can be used according to particular needs, desires, or particular implementations of the computer 2402 and the described functionality. Generally, the processor 2405 can execute instructions and can manipulate data to perform the operations of the computer 2402, including operations using algorithms, methods, functions, processes, flows, and procedures as described in the present disclosure.

The computer 2402 also includes a database 2406 that can hold data for the computer 2402 and other components connected to the network 2430 (whether illustrated or not). For example, database 2406 can be an in-memory, conventional, or a database storing data consistent with the present disclosure. In some implementations, database 2406 can be a combination of two or more different database types (for example, hybrid in-memory and conventional databases) according to particular needs, desires, or particular implementations of the computer 2402 and the described functionality. Although illustrated as a single database 2406 in FIG. 24, two or more databases (of the same, different, or combination of types) can be used according to particular needs, desires, or particular implementations of the computer 2402 and the described functionality. While database 2406 is illustrated as an internal component of the computer 2402, in alternative implementations, database 2406 can be external to the computer 2402.

The computer 2402 also includes a memory 2407 that can hold data for the computer 2402 or a combination of components connected to the network 2430 (whether illustrated or not). Memory 2407 can store any data consistent with the present disclosure. In some implementations, memory 2407 can be a combination of two or more different types of memory (for example, a combination of semiconductor and magnetic storage) according to particular needs, desires, or particular implementations of the computer 2402 and the described functionality. Although illustrated as a single memory 2407 in FIG. 24, two or more memories 2407 (of the same, different, or combination of types) can be used according to particular needs, desires, or particular implementations of the computer 2402 and the described functionality. While memory 2407 is illustrated as an internal component of the computer 2402, in alternative implementations, memory 2407 can be external to the computer 2402.

The application 2408 can be an algorithmic software engine providing functionality according to particular needs, desires, or particular implementations of the computer 2402 and the described functionality. For example, application 2408 can serve as one or more components, modules, or applications. Further, although illustrated as a single application 2408, the application 2408 can be implemented as multiple applications 2408 on the computer 2402. In addition, although illustrated as internal to the computer 2402, in alternative implementations, the application 2408 can be external to the computer 2402.

The computer 2402 can also include a power supply 2414. The power supply 2414 can include a rechargeable or non-rechargeable battery that can be configured to be either user- or non-user-replaceable. In some implementations, the power supply 2414 can include power-conversion and management circuits, including recharging, standby, and power management functionalities. In some implementations, the power-supply 2414 can include a power plug to allow the computer 2402 to be plugged into a wall socket or a power source to, for example, power the computer 2402 or recharge a rechargeable battery.

There can be any number of computers 2402 associated with, or external to, a computer system containing computer 2402, with each computer 2402 communicating over network 2430. Further, the terms “client,” “user,” and other appropriate terminology can be used interchangeably, as appropriate, without departing from the scope of the present disclosure. Moreover, the present disclosure contemplates that many users can use one computer 2402 and one user can use multiple computers 2402.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

Wireless connections within the scope of the present disclosure include wireless protocols, such as, 802.15 protocols (e.g., a BLUETOOTH®), 802.11 protocols, 802.20 protocols (e.g., WI-FIC), or a combination of different wireless protocols.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Without in any way limiting the scope, interpretation, or application of the claims appearing below, a technical effect of one or more of the example implementations disclosed herein is automatically altering a configuration of a cutterbar of a header in response to at least one of extension and retraction of a gauge wheel of the header.

While the above describes example implementations of the present disclosure, these descriptions should not be viewed in a limiting sense. Rather, other variations and modifications may be made without departing from the scope and spirit of the present disclosure as defined in the appended claims.

What is claimed is:

1. A system for automatically configuring a cutterbar of an agricultural header, the system comprising:
a gauge wheel moveable between an extended position and a retracted position;
a sensor that detects a position or an amount of movement of the gauge wheel; and
a cutterbar movable between a flexible configuration and a rigid configuration, the cutterbar moveable into the rigid configuration in response to detection, by the sensor, of a selected position or a selected amount of movement of the gauge wheel as the gauge wheel moves into the extended position.

2. The system of claim 1, wherein the sensor comprises a switch, and wherein the switch is actuated in response to at least one of extension of the gauge wheel and retraction of the gauge wheel.

3. The system of claim 2, wherein actuation of the switch in response to extension of the gauge wheel comprises moving the switch to form one of a closed electrical circuit and an open electrical circuit.

4. The system of claim 2, wherein the sensor comprises a pivotable rotor that includes a surface, wherein the switch comprise an arm that follows the surface.

5. The system of claim 4, further comprising a rod extending between the gauge wheel and the pivotable rotor of the sensor, the rod moveable in response to movement of the gauge wheel to cause the rotor to pivot about an axis.

6. The system of claim 5, wherein extension of the gauge wheel comprises rotation of the gauge wheel about a first axis in a first rotational direction, wherein the rotor is pivoted by the rod in response to movement of the gauge wheel in one of the first rotational direction or a second rotational direction, opposite the first direction.

7. The system of claim 4, wherein the surface comprises a ramp, wherein the arm follows the ramp to actuate the switch to form one of an open electrical circuit and a closed electrical circuit.

8. The system of claim 1, wherein a position or an amount of movement of the gauge wheel detected by the sensor comprises a position or an amount of movement corresponding to a selected amount of extension of the gauge wheel.

9. The system of claim 8, wherein the selected amount of extension of the gauge wheel comprises an amount of extension within a range of 10% to 20% of an entirety of extension of the gauge wheel.

10. The system of claim 1, further comprising at least one pivotably mounted float arm,
wherein the at least one pivotably mounted float arm is connected to the cutterbar at a first end,
wherein the at least one pivotably mounted float arm is moveable between a freely pivotably condition and a fixed condition,
wherein the at least one pivotably mounted float arm is in the freely pivotably condition when the cutterbar is in the flexible condition, and
wherein the at least one pivotably mounted float arm is moved to the fixed condition to place the cutterbar in the rigid configuration in response to detection of the position of the gauge wheel by the sensor.

11. A method of automatically configuring a cutterbar of an agricultural header, the method comprising:
moving a gauge wheel by one of extending and retracting the gauge wheel of an agricultural header;
sensing movement of the gauge wheel with a sensor; and
automatically moving a cutterbar of the agricultural header into one of a rigid configuration when the sensed movement of the gauge wheel is extension of the gauge wheel and a flexible configuration when the sensed movement of the gauge wheel is retraction of the gauge wheel.

12. The method of claim 11, wherein sensing movement of the gauge wheel with a sensor comprises actuating an electrical switch.

13. The method of claim 11, wherein sensing movement of the gauge wheel with a sensor comprises pivoting a rotor of the sensor that includes a profiled surface.

14. The method of claim 13, wherein pivoting the rotor comprises following the profiled surface of the rotor with an arm of the sensor to form one of an open electrical circuit or a closed electrical circuit.

15. The method of claim 13, wherein pivoting a rotor that includes the profiled surface comprises:
displacing a rod extending between the gauge wheel and the rotor; and
rotating the rotor a selected amount about an axis in response to the displacement of the rod.

16. The method of claim 15, wherein the gauge wheel comprises a gauge wheel assembly,
wherein the gauge wheel assembly comprises a gauge wheel arm, the gauge wheel pivotably attached to the gauge wheel arm, and
wherein the rod is pivotably attached at a location along the arm at a first end and pivotably attached to the rotor at a second end.

17. The method of claim 11, wherein automatically moving a cutterbar of the agricultural header into one of a rigid configuration when the sensed movement of the gauge wheel is extension of the gauge wheel and a flexible configuration when the sensed movement of the gauge wheel is retraction of the gauge wheel comprises pivoting a float arm from one of a first position in which the float arm is in a freely pivotable condition and a second position in which the float arm is in a fixed condition.

18. The method of claim 17, wherein the cutterbar is attached to a distal end of the float arm.

19. The method of claim 17, wherein pivoting the float arm from one of the first position in which the float arm is in the freely pivotable condition and the second position in which the float arm is in the fixed condition comprises one of extending and retracting a linear actuator.

20. The method of claim 19, wherein the linear actuator comprises a fluidic cylinder.
